(19) United States
(12) Patent Application Publication
(10) Pub. No.: US 2023/0247634 A1
(43) Pub. Date: Aug. 3, 2023

(54) COMMUNICATION APPARATUS AND COMMUNICATION METHOD

(71) Applicant: SONY GROUP CORPORATION, TOKYO (JP)

(72) Inventors: MASANORI SATO, TOKYO (JP); SAWAKO KIRIYAMA, TOKYO (JP); KOJI KAKINUMA, TOKYO (JP)

(21) Appl. No.: 17/613,537

(22) PCT Filed: Apr. 20, 2020
(86) PCT No.: PCT/JP2020/017104

§ 371 Date: Sep. 6, 2022

(30) Foreign Application Priority Data
Jun. 3, 2019 (JP) 2019-103584

(51) Int. Cl. H04W 72/20; H04W 72/044

(52) U.S. Cl. CPC H04W 72/20; H04W 72/044

(57) ABSTRACT

[Object] Provided is a communication apparatus that performs radio communication of data without exchanging control information in advance.

[Solving Means] A communication apparatus includes: a communication unit that transmits and receives a radio signal; a determination unit that determines a radio resource to be used by the communication unit; and a control unit that controls an operation of transmitting and receiving a radio signal by the communication unit on the basis of the radio resource determined by the determination unit, in which the determination unit determines a radio resource used for transmission of a radio signal according to a radio resource determination rule corresponding to a desired transmission period, and the control unit performs control so that the radio signal is transmitted from the communication unit at the desired transmission period.

### TECHNICAL FIELD

The technology disclosed in this specification relates to a communication apparatus and a communication method using a radio technology.

### BACKGROUND ART

The field of Internet of Things (IoT) is expected to create new value by acquiring and analyzing information from various objects. Although various requirements are expected for IoT, the demand for low power consumption of terminals is particularly high. By reducing the power consumption, terminals can be driven for a longer time. In addition, since terminals can be driven by a smaller battery, downsizing of terminals can be realized and the terminals can be used for more applications. There is high expectation for lower power consumption in radio technology used as means for acquiring information from IoT terminals.

As a technique for achieving lower power consumption of terminals, simplification of communication procedures has been studied. In a conventional mobile phone, a wireless local area network (LAN), or the like, a terminal can transmit data after receiving a notification signal such as a control signal or a beacon periodically transmitted by a base station or an access point, transmitting a connection request, and receiving a connection permission. In such a series of procedures, it is necessary to exchange many control signals before data transmission, and a large amount of power is consumed. In particular, in the field of IoT, the data transmitted by a terminal is mainly a small amount of sensor information of about several tens of bytes such as position information, temperature, and humidity. In the conventional connection procedure, the overhead of a control signal with respect to data is large, and power loss is a problem.

In the field of IoT, a method has been studied in which a terminal can start data transmission with low power consumption while eliminating exchange of control information. However, when the exchange of control information is eliminated, a base station cannot grasp the time and frequency at which the terminal transmits data in advance, and thus, it is necessary to constantly detect and demodulate the radio frame. As a result, it is necessary to improve the functionality of the base station, and the cost of the entire radio system increases.

Therefore, a radio system is considered in which both a terminal and a base station perform time synchronization on the basis of a common time acquired using a global positioning system (GPS) receiver (see, for example, Patent Document 1). In this radio system, a radio resource determination rule for determining a time and a frequency at which a terminal transmits data from a transmission period, a time obtained from the GPS, and a terminal ID is shared between the terminal and a base station in advance as a radio standard. The terminal determines a time and a frequency at which the data is transmitted on the basis of the transmission period allocated in advance, the time obtained from the GPS, and the terminal ID of the terminal. One base station also determines a time and a frequency at which data should be received from the terminal according to a similar method. Since the base station can limit the time and the frequency at which data is received from the terminal in advance, the base station can be realized at a low price, and the cost of the entire radio system can be suppressed.

### PRIOR ART DOCUMENTS

### Patent Document

[Patent Document 1] Japanese Patent No. 6259550

### SUMMARY OF INVENTION

### Problems to be Solved by the Invention

An object of the technology disclosed in this specification is to provide a communication apparatus and a communication method that perform wireless communication of data without exchanging control information in advance.

### Means for Solving the Problems

A first aspect of the technology disclosed in this specification provides a communication apparatus including:

a communication unit that transmits and receives a radio signal;

a determination unit that determines a radio resource to be used by the communication unit; and

a control unit that controls an operation of transmitting and receiving a radio signal by the communication unit on the basis of the radio resource determined by the determination unit, in which

the determination unit determines a radio resource used for transmission of a radio signal according to a radio resource determination rule corresponding to a desired transmission period, and

the control unit performs control so that the radio signal is transmitted from the communication unit at the desired transmission period.

A plurality of radio resource determination rules is defined for each transmission period. The determination unit determines a radio resource to be used for transmitting a radio signal according to a radio resource determination rule selected from radio resource determination rules whose use is permitted in the control information received by the communication unit. The communication apparatus according to the first aspect further includes an acquisition unit that acquires sensor information, and the control unit performs control so that the radio signal in which the sensor information is described is transmitted.

A second aspect of the technology disclosed in this specification provides a communication apparatus including:

a communication unit that transmits and receives a radio signal;

a determination unit that determines a radio resource to be used by the communication unit; and

a control unit that controls an operation of transmitting and receiving a radio signal by the communication unit on the basis of the radio resource determined by the determination unit, in which

the control unit performs control so that a radio signal including control information related to a radio resource determination rule for determining a radio resource to be used for transmitting a radio signal addressed to the communication apparatus is transmitted using the radio resource determined by the determination unit.

A third aspect of the technology disclosed in this specification provides a communication apparatus including:

a communication unit that transmits and receives a radio signal;

a determination unit that determines a radio resource to be used by the communication unit; and

a control unit that controls an operation of transmitting and receiving a radio signal by the communication unit on the basis of the radio resource determined by the determination unit, in which

the control unit performs control so that a radio signal including control information related to a radio resource determination rule for determining a radio resource to be used for transmitting a radio signal addressed to the communication apparatus is transmitted using the radio resource determined by the determination unit.

A fourth aspect of the technology disclosed in this specification provides a communication method including:

selecting a radio resource determination rule for determining a radio resource to be used for transmitting a radio signal addressed thereto;

determining a radio resource to be used for transmitting a radio signal including control information related to the selected radio resource determination rule; and

transmitting the radio signal using the determined radio resource.

### Effects of the Invention

According to the technology disclosed in this specification, it is possible to provide a communication apparatus and a communication method capable of changing a transmission period while determining a transmission time and a transmission frequency according to a radio resource determination rule.

Note that the effects described in this specification are merely examples, and the effects brought by the technology disclosed in this specification are not limited thereto. Furthermore, the technology disclosed in this specification may further exhibit additional effects in addition to the above effects.

Still other objects, features, and advantages of the technology disclosed in this specification will become apparent from a more detailed description based on embodiments to be described later and the accompanying drawings.

### BRIEF DESCRIPTION OF DRAWINGS

FIG. 1 is a diagram illustrating a configuration example of time in a radio system.

FIG. 2 is a diagram illustrating a pseudorandom number sequence generator.

FIG. 3 is a diagram illustrating a state in which an initial value is set in the pseudorandom number sequence generator illustrated in FIG. 2 to generate a pseudorandom number sequence.

FIG. 4 is a diagram illustrating a method of determining a Grid number from a bit sequence obtained by a pseudorandom number sequence generator.

FIG. 5 is a diagram illustrating how the pseudorandom number sequence generator illustrated in FIG. 2 newly generates a pseudorandom number sequence for determining a transmission frequency.

FIG. 6 is a diagram illustrating a method of determining a frequency to be used for transmission of each time slot from an 8-bit sequence newly generated by a pseudorandom number sequence generator.

FIG. 7 is a diagram illustrating a configuration example of a radio system.

FIG. 8 is a diagram illustrating a state in which a terminal 100 transmits (uplinks) to a base station 200.

FIG. 9 is a diagram illustrating a configuration example of an uplink radio frame.

FIG. 10 is a block diagram of a correlation calculator.

FIG. 11 is a diagram illustrating an output image of the correlation calculator illustrated in FIG. 10.

FIG. 12 is a diagram illustrating an exemplary frame configuration of an uplink radio resource control signal.

FIG. 13 is a diagram illustrating a configuration example of a UL Resource Control field.

FIG. 14 is a diagram illustrating a state in which a base station 200 and a terminal 100 perform transmission.

FIG. 15 is a diagram illustrating an example of a communication sequence in a radio system.

FIG. 16 is a diagram illustrating a configuration example of the terminal 100.

FIG. 17 is a diagram illustrating a configuration example of a terminal 101.

FIG. 18 is a diagram illustrating a configuration example of the base station 200.

FIG. 19 is a flowchart illustrating a processing procedure executed by a terminal.

FIG. 20 is a flowchart illustrating a processing procedure executed by the base station 200.

FIG. 21 is a diagram illustrating a configuration example of a UL Resource Control field 1203 used in a second embodiment.

FIG. 22 is a diagram illustrating a configuration example of the UL Resource Control field 1203 used in a third embodiment.

FIG. 23 is a diagram illustrating a modification of the UL Resource Control field 1203 used in a third embodiment.

FIG. 24 is a diagram illustrating a modification of the UL Resource Control field 1203 used in a fourth embodiment.

FIG. 25 is a diagram illustrating a modification of the UL Resource Control field 1203 used in the fourth embodiment.

FIG. 26 is a diagram illustrating an example of a radio system.

### MODE FOR CARRYING OUT THE INVENTION

Hereinafter, embodiments of the technology disclosed in this specification will be described in detail with reference to the drawings.

According to the radio standard (described above) in which a transmission time and a transmission frequency at which a terminal transmits data are determined from a transmission period, a time obtained from the GPS, and a terminal ID according to a predetermined radio resource determination rule, the period in which the terminal transmits data (sensor information or the like) in a radio system is limited to the specified period.

On the other hand, there is a case where it is desired to change the data transmission period of the terminal. For example, by performing transmission at a shorter period after the terminal is powered on, it is possible to quickly confirm the arrival of data. In addition, when the sensor information is suddenly changed in the terminal, it may be desired to transmit the sensor information to the base station at a shorter period than usual. In addition, there is a case where it is desired to temporarily change the data collection period according to a request from a customer.

Therefore, in this specification, a technology related to a radio system capable of appropriately changing a data transmission period of a terminal while eliminating the need for exchanging control information between a terminal and a base station by determining a data transmission time and a transmission period of the terminal according to a predetermined radio resource determination rule is proposed below. According to the technology proposed in this specification, a plurality of radio resource determination rules is defined, and the terminal can select a necessary radio resource determination rule and perform data transmission.

### First Embodiment

The first embodiment will be described in the following order.

A. Radio Resource Determination Rule Using GPS Time

B. Data Transmission/Reception Method Based on Radio Resource Determination Rule Using GPS Time

C. Problem

D. Proposed Method

A. Radio Resource Determination Rule Using GPS Time

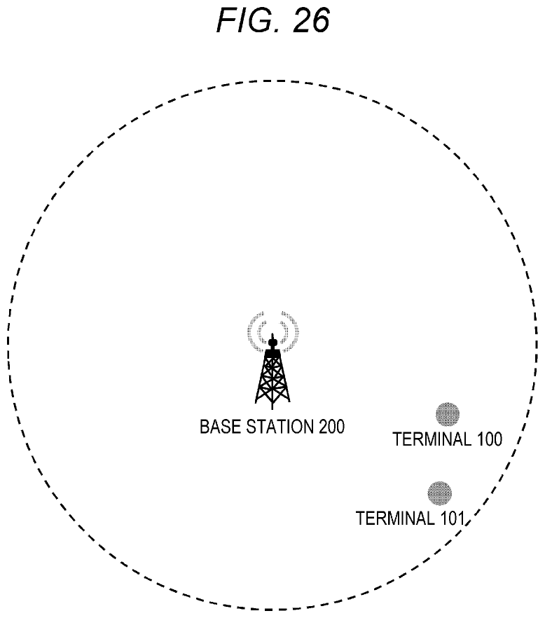

FIG. 26 illustrates an example of a radio system assumed in the present embodiment. The illustrated radio system includes one base station 200, and a terminal 100 and a terminal 101 present in a range where signals from the base station can be received. In the drawing, the ranges where signals from the base station 100 and the terminals 100 and 101 can be received are surrounded by dotted lines. Each of the terminals 100 and 101 is, for example, an IoT device equipped with a sensor function, and transmits data including the acquired sensor information to the base station 200.

For simplification of the drawings, only two terminals are illustrated in the receivable range of the base station 200, but actually, it is assumed that three or more or a large number of terminals are accommodated in the receivable range. As will be described later, the base station 200 downlink-transmits control information with a small data amount to control terminals within the receivable range. The base station can transmit control information with a small amount of data by increasing the transmission energy per bit. As a result, long-distance communication of control information is easily realized, and the base station can control remote terminals altogether. In addition, since the reception time of the control information is short for the terminal, low power consumption can be realized.

The base station 200 and the terminals 100 and 101 have a GPS receiver mounted thereon, and acquire time information by receiving a GPS signal to synchronize internal clocks in the devices. First, a radio resource determination rule for determining a time and a frequency at which a terminal transmits data using the GPS time obtained from a GPS receiver will be described below.

A-1. Determination of Transmission Time

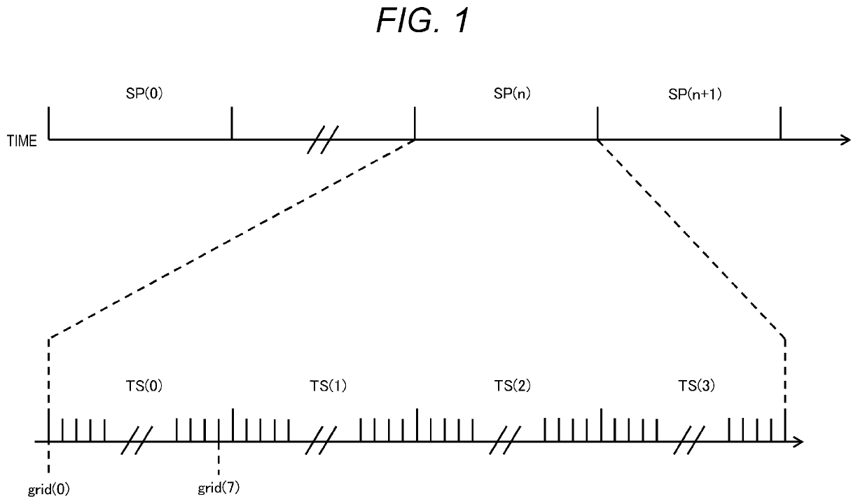

FIG. 1 illustrates a configuration example of time in a radio system according to the present embodiment. As illustrated in the drawing, in the radio system, time is divided into superframes (SP) having a predetermined length, each superframe is divided into a plurality of (four in the illustrated example) time slots (TS), and each time slot is further divided into a plurality of (eight in the illustrated example) grids (Grid). Hereinafter, the serial number of the superframe is referred to as an SP number.

A-1-1. SP Number and SP Start Time for Transmission

First, the current SP number and the start time of the superframe of the SP number are determined from the GPS time. The GPS time acquired from the GPS signal is defined as t. The time obtained from the GPS time is based on 0:00:00 on Jan. 6, 1980. Here, it is considered as the unit of seconds. Further, the length of the superframe section is defined as SP_{duration}. The length of the superframe section is determined in advance in a radio system.

At this time, when an SP number is n and the start time of the superframe with the number n is SP(n)ₛₜₐᵣₜ₋ₜᵢₘₑ, they can be determined as in the following equations (1) and (2). Note that the operator div( ) indicates the quotient of division.

[Math. 1]

n=div(t,SP_{duration}) (1)

[Math. 2]

SP(n)ₛₜₐᵣₜ₋ₜᵢₘₑ=n×SP_{duration} (2)

According to the above equations (1) and (2), the start time SP(n)ₛₜₐᵣₜ₋ₜᵢₘₑ of the superframe SP(n) whose serial number is the quotient obtained by dividing the GPS time t by the superframe section SP_{duration} is a value obtained by multiplying n by the superframe section length. For example, when SP_{duration}=20 seconds and GPS time=105 seconds, n=5 and SP(5)ₛₜₐᵣₜ₋ₜᵢₘₑ=100 seconds.

Next, an SP number that can be transmitted by the terminal is determined. This is determined using a transmission period (Period) allocated in advance and a terminal identifier (ID) as information unique to the terminal. Since the determination is made using the terminal ID which is information unique to the terminal, different SP numbers are allocated to the terminals even if the transmission period is the same.

Here, the transmission period Period expressed in seconds is converted into the number of superframes, that is, an interval (m) of SP numbers. Specifically, according to the following equation (3), the quotient obtained by dividing the transmission period Period allocated in advance by the superframe section length SP_{duration} is defined as the interval m of SP numbers.

[Math. 3]

m=div(Period,SP_{duration}) (3)

Next, in order to change the SP number for each terminal, an offset value m_{oft} is calculated according to the following equation (4). However, the operator mod( ) in the following equation (4) indicates the remainder of the division. That is, the remainder obtained by dividing the terminal ID by the interval m of the SP numbers is the offset value m_{oft} of the terminal.

[Math. 4]

m_{ofv}=mod(ID,m) (4)

Then, the SP number (n) that can be transmitted by the terminal is determined using the offset value m_{oft}. Specifically, when the SP number (n) satisfies the following equation (5), the terminal can perform transmission. That is, the terminal can perform transmission in the superframe with the SP number (n) in which the value obtained by adding the offset value m_{oft} can be divided by the interval (m) of the SP numbers corresponding to the transmission period.

[Math. 5]

mod(n+m_{oft},m)=0 (5)

For example, when SP_{duration}=20 seconds, GPS time=105 seconds, transmission period=3 minutes (180 seconds), and the terminal identifier is ID=1, m=9 and m_{oft}=1. Thus, the terminal can perform transmission when the SP number is n=8, 17, 26, . . . , and so on. Therefore, since the SP_{duration} is 20 seconds, a transmission opportunity is allocated to the terminal every 160 seconds (n=8), 340 seconds (n=17), 520 seconds (n=26), and transmission period of 3 minutes (18 seconds).

A-1-2. Transmission Start Time (Grid Determination) in Superframe

Next, the transmission time in the superframe of the SP number determined above is determined. The superframe is divided into a plurality of time slots (TS). In the example illustrated in FIG. 1, one superframe is divided into four time slots. It is assumed that the terminal performs repetitive transmission in each time slot. The repetitive transmission is that the terminal transmits the same data a plurality of times, which can increase the success rate of communication and can realize long-distance communication. The repetitive transmission is performed for the number of time slots in the superframe. There may be one time slot in the superframe, but repetitive transmission is not performed in this case.

The transmission start time in each time slot can be determined by the start time of the corresponding superframe and the number of time slots in the superframe. Assuming that the number of divisions of the time slot in the n-th superframe SP(n) is nTS, the start time TS (k) start-time in SP(n) of the k-th time slot TS(k) in the superframe is determined according to the following equation (6). Here, k is an integer from 0 to (nTS−1), and nTS=4 in the example illustrated in FIG. 1.

$$\begin{matrix}[ Math . 6 ] & \\ {TS ( k )}_{start - time in SP ( n )} = {SP ( n )}_{start - time} + k \times \frac{{SP}_{duration}}{nTS} & ( 6 )\end{matrix}$$

A plurality of transmission start times called grid is defined in the time slot. In the example illustrated in FIG. 1, eight start times of grid(0) to grid(7) are defined for each time slot. The grid in which a terminal performs transmission is determined using a pseudorandom number sequence.

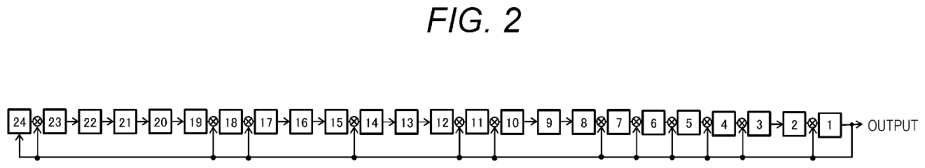

FIG. 2 illustrates an example of a pseudorandom number sequence generator. This indicates one of generators of general pseudorandom numbers (PN) sequences. A method of generating a pseudorandom number sequence using the generator illustrated in FIG. 2 will be described.

First, an initial value is set in the generator. The initial value refers to 0/1 bit set as the initial value of the delay element indicated by the square box in FIG. 2. In the example illustrated in FIG. 2, since the generator includes delay elements of 1 to 24, a 24-bit initial value is set. Such a pseudorandom number sequence generator has a characteristic that the generated pseudorandom number sequence is different if the initial value is different (or from the same initial value, a determined value based on the initial value is always output).

After setting the initial value, the output (OUTPUT) is output by 1 bit by moving one clock of the generator. That is, the value set in the delay element 1 in FIG. 2 is output. At the same time, the output is provided at the points connected by the lines in FIG. 2. The circles with a multiplication symbol x in FIG. 2 indicate a logical operation of exclusive OR (XOR). For example, the output is calculated by XOR with the output of the delay element 2 and stored in the delay element 1. Hereinafter, similarly, necessary calculation is performed to update the value of each delay element. By sequentially moving the clock, it is possible to obtain output bits of a necessary length.

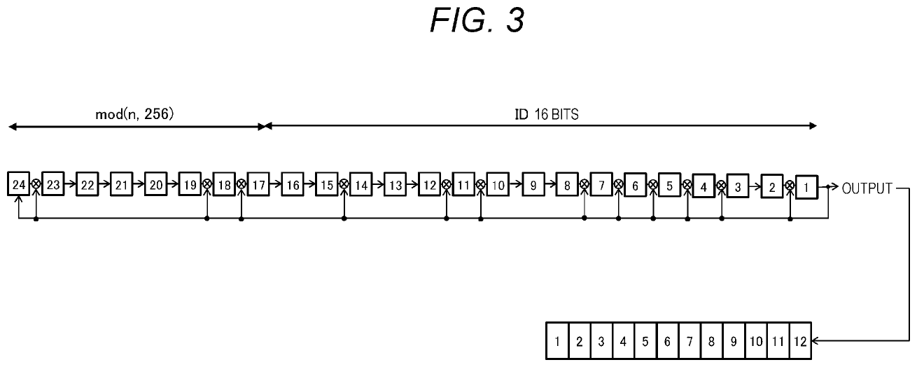

In order to determine the grid in which each terminal performs transmission, the terminal ID and the SP number are set to the initial value of the pseudorandom number sequence illustrated in FIG. 2, and a 12-bit pseudorandom number sequence is generated. FIG. 3 illustrates a state in which a terminal ID and an SP number are set to the initial value of the pseudorandom number sequence generator illustrated in FIG. 2 to generate a pseudorandom number sequence. In the example illustrated in FIG. 3, a total of 24 bits obtained by concatenating 16 bits of the terminal ID to the remainder 8 bits obtained by dividing the SP number n by 256 is set as the initial value. After that, the clock is moved only 12 times to generate a 12-bit pseudorandom number sequence.

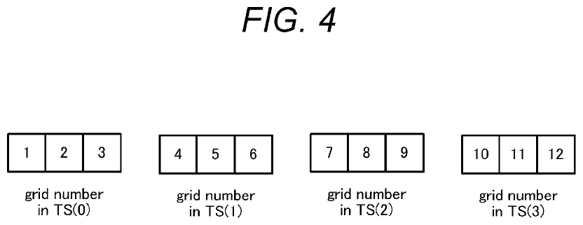

As illustrated in FIG. 3, the pseudorandom number sequence generator determines the Grid number using 12 bits generated from the initial value based on the terminal ID and the SP number. FIG. 4 illustrates a method of determining the Grid number from the 12-bit sequence obtained by the pseudorandom number sequence generator. In the example illustrated in FIG. 4, 12 bits are divided into four groups of 3 bits, and the results obtained by converting the respective 3 bits into decimal numbers are determined as Grid numbers in which transmission is performed in the time slots (TS) of TS(0), TS(1), TS(2), and TS(3).

Since the number of delay elements used by the pseudorandom number sequence generator illustrated in FIG. 2 is 24, a part of the terminal ID and the SP number (the remainder 8 bits obtained by dividing the SP number n by 256) is set as the initial value. However, using a pseudorandom number sequence generator including more delay elements, a longer terminal ID or SP number can be used as the initial value. In addition, in the example illustrated in FIG. 1, since the number of time slots in the superframe is 4 and the number of grids in the time slot is 8, the grid number is determined from the 12-bit sequence. However, even in a case where the number of time slots and the number of grids in the time slot are different, it is possible to generate a pseudorandom number having a necessary length using the pseudorandom number sequence generator illustrated in FIG. 2.

A-2. Determination of Transmission Frequency

The number of frequency channels available as a radio system is denoted as n_{F}. Here, it is assumed that n_{F}=4. In the example illustrated in FIG. 1, since transmission is performed four times (once per time slot) in one superframe, an example of determining a transmission frequency used for the four times of transmission will be described.

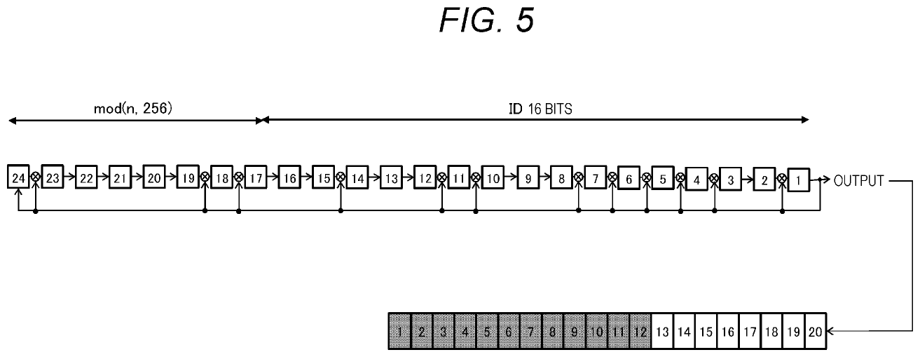

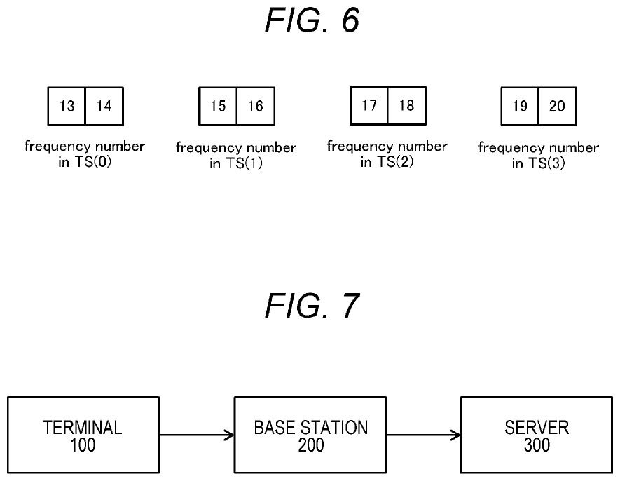

In the pseudorandom number sequence generation method illustrated in FIG. 3, an 8-bit pseudorandom number sequence is further generated after 12 bits generated for determining the transmission time (Grid number in the time slot). This state is illustrated in FIG. 5, and the newly generated pseudorandom number sequence is 8 bits of 13 to 20. Then, FIG. 6 illustrates a method of determining a frequency used for transmission in each time slot from the 8-bit sequence newly generated by the pseudorandom number sequence generator. Since n_{F}=4, in the example illustrated in FIG. 6, 8 bits are divided into four groups of 2 bits, and the results obtained by converting the respective 2 bits into decimal numbers are set as the transmission frequency numbers. The frequency number corresponds to the center frequency of the carrier frequency when transmission is performed actually.

Note that, in the above description, since the number of available frequencies is four (n_{F}=4), the number of time slots in one superframe is four for each of 2 bits, the pseudorandom number sequence generator is generated from a total of 8 bits in four groups. However, a pseudorandom number sequence having a necessary length can be generated according to the number of available frequencies and the number of time slots to be extended.

As described above, it is possible to determine the transmission time and the transmission frequency in a case where a terminal performs transmission in a fixed period on the basis of the GPS time and the terminal ID. Since the GPS time is used and the terminal ID is used, it is possible to allocate different time and frequency to each terminal, and it is possible to allocate different time and frequency depending on the transmission time.

Note that, although detailed description is omitted in this specification, it is assumed that the base station can similarly determine the transmission time and the transmission frequency in a case where the base station performs transmission at a fixed period on the basis of the GPS time and the ID.

B. Data Transmission/Reception Method Based on Radio Resource Determination Rule Using GPS Time

Next, as illustrated in FIG. 7, a method of transmitting and receiving data between the terminal 100 and the base station 200 in a radio system including the terminal 100, the base station 200, and a server 300 will be described. However, in FIG. 7, for simplification of description, only one terminal 100, one base station 200, and one server 300 are illustrated, but a radio system in which a plurality of terminals 100, a plurality of base stations 200, and a plurality of servers 300 are present is also conceivable.

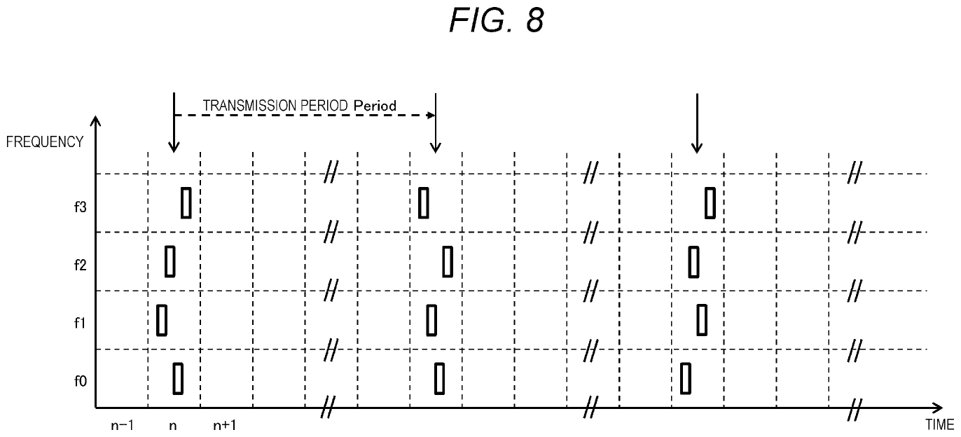

FIG. 8 illustrates a state in which the terminal 100 transmits (uplinks) to the base station 200. However, in the drawing, the vertical axis represents frequency, and the horizontal axis represents time. In addition, a dotted line of the horizontal axis indicates the section of each superframe. For example, the terminal 100 performs repetitive transmission four times in the superframe in each transmission period (Period 1 in FIG. 8) on the basis of the radio resource determination rule described in Section A. In the example illustrated in FIG. 8, four frequency channels of f0 to f3 are used for transmission of radio frames, and the radio frames are transmitted at different transmission timings while hopping between respective frequency channels. In FIG. 8, the uplink signal transmitted by the terminal 100 is indicated by a blank box.

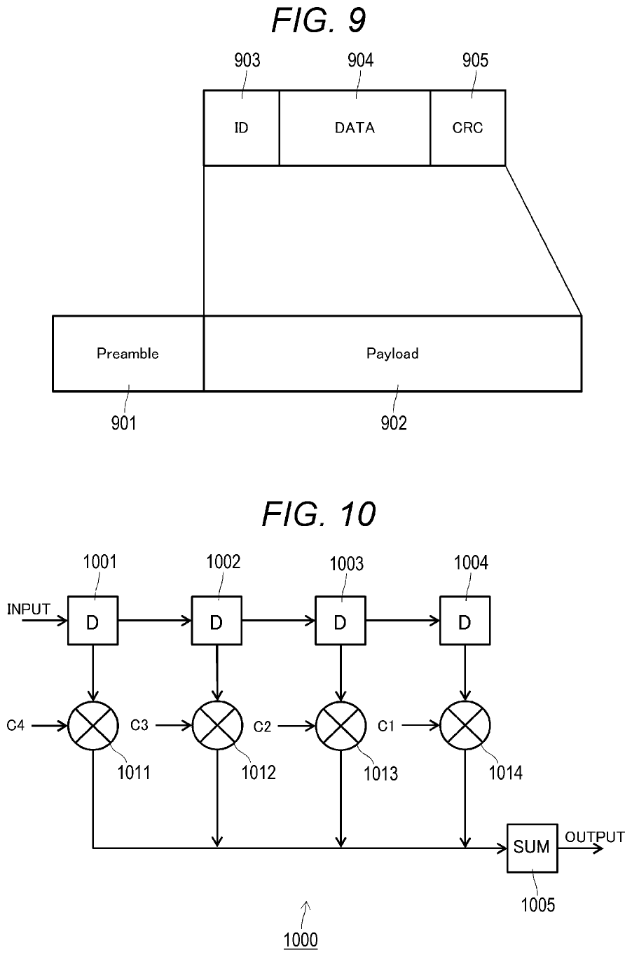

FIG. 9 illustrates a configuration example of an uplink radio frame transmitted by the terminal 100. The illustrated radio frame includes a preamble 901 and a payload 902.

The preamble 901 includes an uplink specific pattern. The reception side (for example, the base station 200) detects a radio frame by calculating the correlation between the unique pattern of the preamble and the received signal. Details of a radio frame detection method will be described later.

The payload 902 includes an ID field 903, a DATA field 904, and a CRC field 905.

The ID field 903 stores an identifier (terminal ID) of a terminal that transmits the uplink radio frame. In addition, the DATA field 904 stores transmission data such as sensor information.

The CRC field 905 stores a value of a cyclic redundancy code calculated on the basis of the values stored in the ID field 903 and the DATA field 904.

The reception side (for example, the base station 200) can recalculate the value of CRC on the basis of the received values stored in the ID field 903 and DATA field 904, and determine whether the reception of the radio frame has succeeded or failed depending on whether or not the recalculated value matches the received value of the CRC field 905.

The terminal 100 which is the transmission side of the uplink radio frame performs signal processing such as error correction and interleaving on the respective values of ID, DATA, and CRC, and then stores the respective values in the ID field 903, the DATA field 904, and the CRC field 905 in the payload 902.

Note that the error correction is signal processing for enhancing noise resistance performance of a communication path, and in the present embodiment, general signal processing such as low density parity check (LDPC) and convolutional codes is assumed. In error correction, noise resistance is enhanced by adding redundant information to an input signal, and thus an output length is generally longer than an input length. In addition, interleaving is processing of rearranging the order of data in advance in order to reduce the influence of burst noise.

Subsequently, a method of detecting the uplink radio frame illustrated in FIG. 9 on the receiving side will be described. As described above, the radio frame is detected by calculating the correlation between the unique pattern of the preamble and the received signal.

FIG. 10 illustrates a block diagram of a correlation calculator 1000. “INPUT” is a received signal (after digital conversion). The received signal is input to delay elements (in FIG. 10, block labeled with “D”) 1001 to 1004 that delay one sample for each sample. In FIG. 10, a bit sequence of C4, C3, C2, and C1 is a known preamble pattern. Multiplication of the output of the delay elements 1001 to 1004 by C4, C3, C2, and C1 is performed by multipliers 1011 to 1014, and the addition of the multiplication results is calculated in an addition block 1005 labeled with “SUM” in FIG. 10. “OUTPUT” is a correlation value between the unique pattern of the preamble and the received signal. Although FIG. 10 illustrates an example in which the preamble has a length of 4 bits, the configuration of FIG. 10 can be extended and applied to a case where a longer preamble pattern is used.

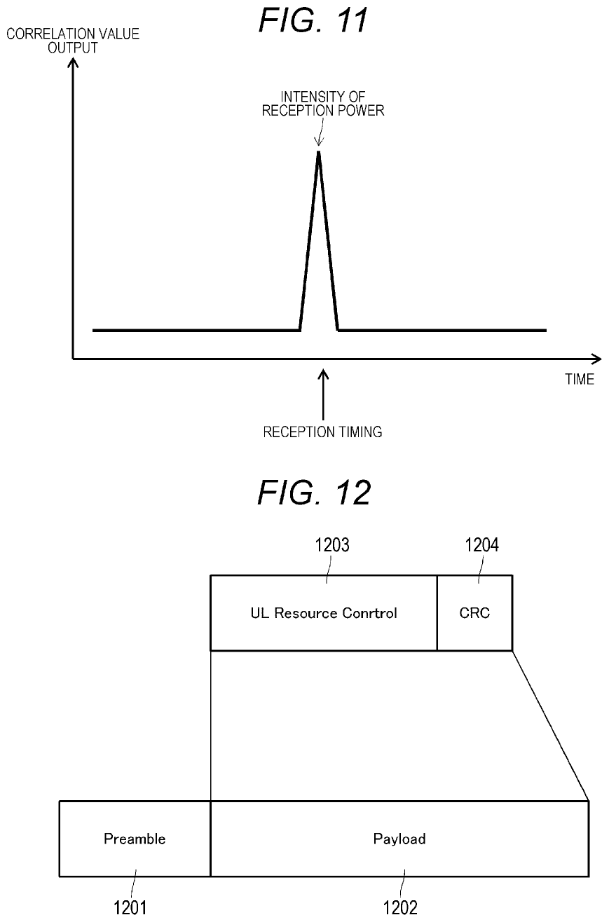

FIG. 11 illustrates an output image of the correlation value OUTPUT calculated by the correlation calculator 1000 illustrated in FIG. 10. Here, a horizontal axis is a time axis, and a vertical axis is a correlation value OUTPUT calculated by the correlation calculator 1000 for each time. The correlation value OUTPUT becomes a large value at the timing when the received signal matches the known preamble pattern, and becomes a small value when the timing deviates. Then, it is possible to detect the radio frame by setting the time at which the correlation value OUTPUT in FIG. 11 peaks as the reception timing of the radio frame. The maximum value of the correlation value OUTPUT is the intensity of the reception power.

In a case where the uplink radio frame is received from the terminal 100, the base station 200 calculates a reception timing and a reception frequency using the radio resource determination rule described above, and performs a reception operation. The timing at which the radio frame is to be received can be calculated in advance according to the radio resource determination rule, but since a delay according to a distance occurs in actual radio propagation, a radio frame is detected using a preamble as described above, and accurate reception timing is detected. The uplink radio frames detected in this manner are added, demodulation processing (signal processing corresponding to error correction or interleaving) is performed, and the CRC is checked to determine whether the reception has succeeded or failed.

In the radio system illustrated in FIG. 7, when it is determined that the uplink radio frame is successfully received from the terminal 100, the base station 200 reports the ID and DATA acquired from the received signal to the server 300.

C. Problem

As described above, in the radio system, the transmission time and the transmission frequency in the case where the terminal performs the transmission at the fixed period can be determined on the basis of the GPS time and the terminal ID according to the radio resource determination rule. Therefore, uplink transmission from the terminal 100 to the base station 200 can be started without exchanging control information between the terminal 100 and the base station 200.

On the other hand, there is a case where it is desired to change the data transmission period of the terminal. For example, by performing transmission at a shorter period after the terminal is powered on, it is possible to quickly confirm the arrival of data. In addition, when the sensor information is suddenly changed in the terminal, it may be desired to transmit the sensor information to the base station at a shorter period than usual. In addition, there is a case where it is desired to temporarily change the data collection period according to a request from a customer.

In the above method of determining on the basis of the GPS time and the terminal ID according to the radio resource determination rule, there is a problem that the period at which the terminal transmits data in the radio system is limited to the specified period.

D. Proposed Method

In order to solve the problem described in Section C, in the present embodiment, a plurality of radio resource determination rules for determining the transmission time and the transmission frequency of the radio frame on the basis of the GPS time and the terminal ID is defined so that the data transmission period of the terminal can be changed.

For example, a reference transmission period or a shorter transmission period is defined, a plurality of radio resource determination rules is defined for different transmission periods, and serial numbers are assigned to the respective rules. For example, radio resource determination rule 1 is defined for a reference transmission period, and radio resource determination rule 2 is additionally defined for a shorter transmission period.

Further, in the present embodiment, it is defined that the base station 200 periodically transmits an uplink radio resource control signal. In the uplink radio resource control signal, the number of an available radio resource determination rule is described in addition to a reference radio resource determination rule (for example, radio resource determination rule 1).

The terminal usually transmits data (sensor information) according to a reference radio resource determination rule (for example, radio resource determination rule 1), and does not need to receive an uplink radio resource control signal. In addition, when the terminal wants to change the transmission period due to the above-described reason or the like, the terminal receives an uplink radio resource control signal, checks an available radio resource determination rule, determines the transmission time and the transmission frequency according to another radio resource determination rule (for example, radio resource determination rule 2) when available, and transmits data. In this way, the data transmission period of the terminal can be changed.

D-1. Definitions of Plurality of Radio Resource Determination Rules

In an uplink in which data is transmitted from a terminal to a base station, a reference radio resource determination rule is defined for a reference transmission period (Period), and a radio resource determination rule is newly defined for a transmission period different from (shorter than) the reference transmission period. When a plurality of transmission periods different from the reference transmission period is used, different radio resource determination rules are defined for the respective transmission period. A radio resource determination rule defined for a reference transmission period is referred to as a “reference radio resource determination rule”, and a newly defined radio resource determination rule is referred to as an “additional radio resource determination rule”. When a plurality of additional radio resource determination rules is defined, they are distinguished by adding serial numbers such as additional radio resource determination rule 1, additional radio resource determination rule 2, . . . , and so on.

The reference transmission period set for the reference radio resource determination rule is a default transmission period determined at the time of initial contract, for example, at the time of purchasing a terminal, and is set to 10 minutes, for example. Hereinafter, the transmission period of the reference radio resource determination rule is also referred to as Period(Def). A different transmission period may be allocated to each terminal (or for each type of terminal or for each purchaser of the terminal) according to a contract content or the like.

In addition, in a case where two transmission periods shorter than the reference transmission period are additionally specified, the respective additional transmission periods are also referred to as, for example, Period(1) and Period(2). The radio resource determination rule defined for Period(1) is also referred to as additional radio resource determination rule 2, and the radio resource determination rule defined for Period(2) is also referred to as additional radio resource determination rule 2.

D-2. Base Station Operation

In the present embodiment, one or more transmission periods shorter than the reference transmission period are additionally defined, and an additional radio resource determination rule is defined for each transmission period. Then, the base station 200 periodically transmits an uplink radio resource control signal describing information regarding the additional radio resource determination rule available in the base station.

Similarly to the terminal 100, the base station 200 also determines a transmission time and a transmission frequency in a case where the base station 200 performs transmission (downlink transmission) at a fixed period on the basis of the GPS time and the ID according to a predetermined radio resource determination rule. Then, the base station 200 periodically transmits the uplink radio resource control signal using the determined transmission time and transmission frequency.

The period at which the base station 200 transmits the signal is also referred to as Period(DL). Period(DL) is a value unique to the radio system, such as 30 minutes. The ID is a value unique to the radio system. The terminal 100 under the control of the base station 200 also has a known ID unique to the radio system, and thus the terminal 100 side can also grasp the transmission time and the transmission frequency of the downlink signal from the base station 200 according to a predetermined radio resource determination rule.

D-2-1. Radio Frame of Uplink Radio Resource Control Signal

FIG. 12 illustrates an exemplary frame configuration of an uplink radio resource control signal. The illustrated radio frame includes a preamble 1201 and a payload 1202.

The preamble 1201 includes an uplink specific pattern. The reception side (for example, the terminal 100) detects the radio frame by calculating the correlation between the unique pattern of the preamble and the received signal. Since the method of detecting a radio frame is similar to the above (see, for example, FIGS. 10 and 11), a detailed description thereof will be omitted here.

The payload 1202 includes an UL Resource Control field 1203 and a CRC field 1204.

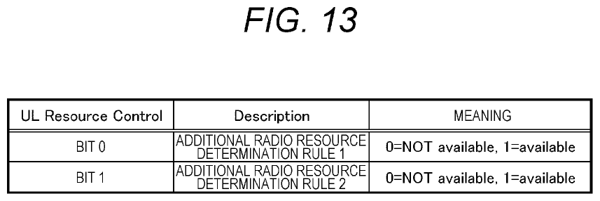

FIG. 13 illustrates a configuration example of the UL Resource Control field 1203. In the UL Resource Control field 1203, a flag (0/1) indicating the availability of an additional radio resource determination rule for determining the uplink transmission method is described. For example, when two radio resource determination rules are additionally defined in addition to the reference radio resource determination rule, a two-bit availability flag is prepared to indicate the availability of each additional radio resource determination rule. When the additional radio resource determination rule is available, 1 is written in the corresponding availability flag, and when the additional radio resource determination rule is unavailable, 0 is written in the corresponding availability flag.

The CRC field 1204 stores a value of CRC calculated on the basis of the value stored in the UL Resource Control field 1203. The reception side (for example, the terminal 100) can recalculate the value of CRC on the basis of the value stored in the received UL Resource Control field 1203, and determine whether the reception of the radio frame has succeeded or failed depending on whether or not the value matches the value of the received CRC field 1204 (same as above).

It is assumed that a valid period can be set in the additional radio resource determination rule permitted by UL Resource Control described in the uplink radio resource control signal. For example, the valid period is defined as one hour in the radio system.

D-2-2. Uplink Resource Control Information Setting Method

Next, a method in which the base station 200 sets information of UL Resource Control will be described.

The processing capacity of the base station 200 is designed on the assumption that a plurality of terminals is connected. However, the terminal to be actually connected is limited to the terminal present in the reception area of the base station 200. Therefore, there may be a surplus in the processing capacity of the base station 200. The base station 200 determines whether or not to permit the additional radio resource determination rule on the basis of the surplus capacity. For example, when a radio resource determination rule having a shorter transmission period is additionally permitted, the base station 200 needs more processing capacity accordingly. Therefore, the base station 200 determines whether or not to permit the additional radio resource determination rule within the range of surplus capacity. For each valid period of the additional radio resource determination rule, the additional radio resource determination rule is only required to be newly permitted within the range of the surplus capacity of the base station 200.

D-3. Terminal Operation

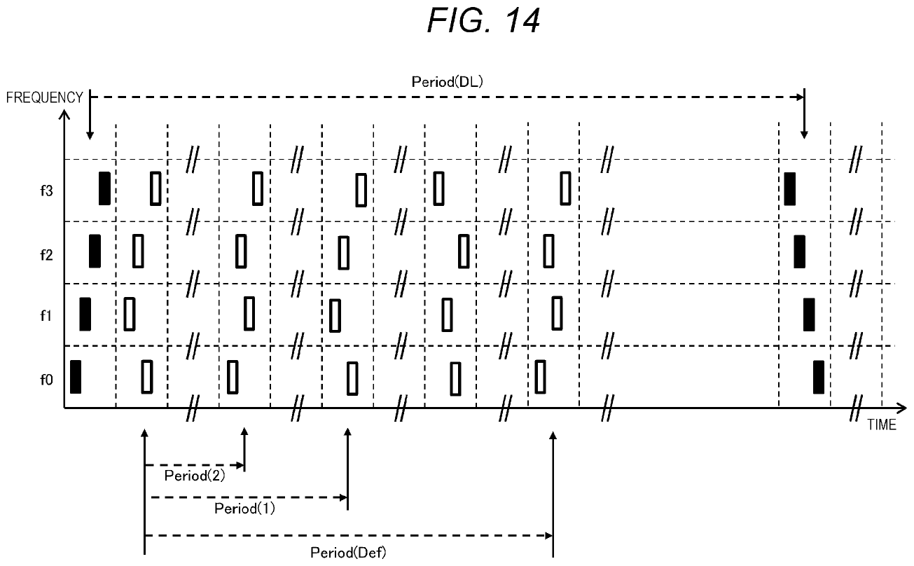

FIG. 14 illustrates a state in which the base station 200 and the terminal 100 perform transmission. However, in the drawing, the vertical axis represents frequency, and the horizontal axis represents time. In addition, a dotted line of the horizontal axis indicates the section of each superframe.

The terminal 100 basically transmits the uplink signal (for example, the radio frame illustrated in FIG. 9) in a default transmission period Period(Def) using the transmission time and the transmission frequency determined on the basis of the GPS time and the terminal ID according to the reference radio resource determination rule. The base station 200 also transmits a downlink signal including an uplink radio resource control signal (see FIG. 12) in a fixed period Period(DL) according to a predetermined radio resource determination rule using a transmission time and a transmission frequency determined on the basis of a GPS time and an ID employed by the radio system. In the example illustrated in FIG. 14, four frequency channels f0 to f3 are used for transmission of a radio frame, and transmission of uplink and downlink radio frames is performed while hopping between the respective frequency channels. In FIG. 14, the uplink radio resource control signal transmitted by the base station 200 is indicated by a solid box, and the uplink signal transmitted by the terminal 100 is indicated by a blank box.

The terminal 100 normally transmits a radio frame using the transmission time and the transmission frequency determined according to the reference radio resource determination rule in a default transmission period Period(Def).

On the other hand, the terminal 100 may want to change (shorten) the transmission period due to the above-described reason. In such a case, the terminal 100 receives an uplink radio resource control signal periodically transmitted by the base station 200, and the terminal 100 checks information of UL Resource Control described in the received uplink radio resource control signal. When the additional radio resource determination rule is permitted and the terminal 100 itself wants to transmit a radio frame at the transmission period determined by the additional radio resource rule, the terminal 100 switches from the reference radio resource determination rule to the additional radio resource determination rule. For example, when the rule is switched to the additional radio resource determination rule 1, the terminal 100 can perform transmission at the transmission period of Period 1 in FIG. 14.

A valid period is set in information (or the additional radio resource determination rule) of UL Resource Control described in the uplink radio resource control signal. Therefore, after receiving the uplink radio resource control signal once, the terminal 100 can continue to use the permitted additional radio resource determination rule without receiving the uplink radio resource control signal during the valid period (for example, 1 hour). After that, when the valid period elapses (or before elapse), the terminal 100 receives the uplink radio resource control signal again and rechecks the information of the UL Resource Control, so that the valid period can be extended, that is, the additional radio resource determination rule can be continuously used.

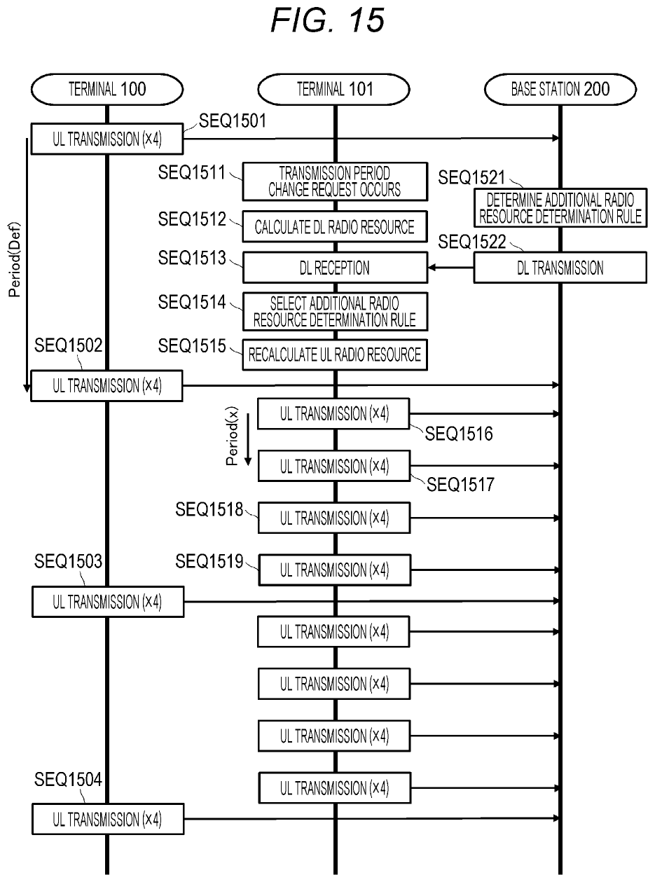

FIG. 15 illustrates an exemplary communication sequence in the radio system. Here, it is assumed that two terminals 100 and 101 are simultaneously connected to the base station 200. Here, the terminal 100 represents a terminal that normally operates according to the reference radio resource determination rule, and the terminal 101 represents a terminal that receives an uplink radio resource control signal and changes a transmission period. In addition, the server 300 is not illustrated in order to simplify the description.

The terminal 100 repeatedly transmits the uplink signal a plurality of times (SEQ1501). Here, it is assumed that the uplink signal is transmitted four times while hopping between the frequency channels f0 to f3. The uplink signal includes, for example, the radio frame illustrated in FIG. 9.

After that, the terminal 100 similarly transmits the uplink signal only (SEQ1502, SEQ 1503, SEQ 1504) according to the reference radio resource determination rule and at the default transmission period Period(Def), and does not receive a downlink signal from the base station 200.

The base station 200 receives the uplink signal repeatedly transmitted four times from the terminal 100. As also illustrated in FIG. 8, the terminal 100 repeatedly transmits the same uplink signal using the four frequency channels f0 to f3. The base station 200 may receive the uplink signal using any one of the receivable frequency channels, or combine the uplink signals received on two or more frequency channels, to improve the signal reception accuracy.

In addition, the base station 200 determines an additional radio resource determination rule that can be permitted in consideration of the current surplus capacity (SEQ1521), and downlink-transmits an uplink radio resource control signal describing information of UL Resource Control based on the determination result (SEQ1522).

On the other hand, the terminal 101 makes a request to change the transmission period for any of the reasons described above (SEQ1511). In response to the transmission period change request, the terminal 101 calculates the transmission time and the transmission frequency of the downlink signal on the basis of the GPS time and the ID unique to the radio system according to a predetermined radio resource determination rule in order to receive the uplink radio resource control signal from the base station 200 (SEQ1512). Then, the terminal 101 receives the uplink radio resource control signal from the base station 200 at the calculated transmission time and transmission frequency (SEQ1513).

The terminal 101 checks the information of UL Resource Control described in the uplink radio resource control signal, and selects the additional radio resource determination rule having a desired transmission period Period(x) (SEQ1514). Then, the terminal 101 recalculates the transmission time and the transmission frequency of the uplink signal on the basis of the GPS time and the ID of the terminal 101 according to the selected additional radio resource determination rule (SEQ1515).

After that, the terminal 101 uplink-transmits the radio frame using the recalculated transmission time and transmission frequency for each transmission period Period(x) (SEQ1516, SEQ 1517, SEQ 1518, . . . , and so on).

D-4. Terminal Configuration (1)

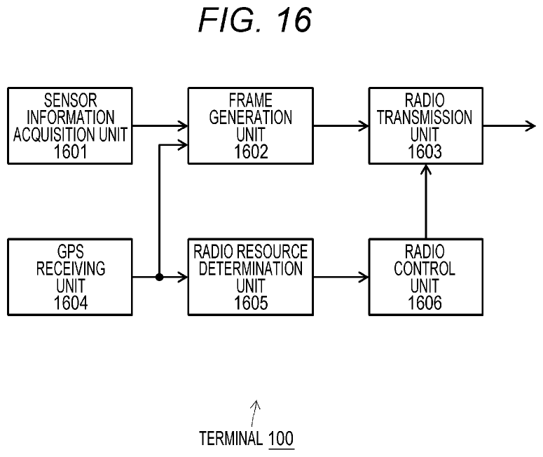

FIG. 16 schematically illustrates a configuration example of the terminal 100. The terminal 100 is a terminal that normally operates according to the reference radio resource determination rule. The terminal 100 includes a sensor information acquisition unit 1601, a frame generation unit 1602, a radio transmission unit 1603, a GPS receiving unit 1604, a radio resource determination unit 1605, and a radio control unit 1606.

The sensor information acquisition unit 1601 selects and acquires sensor information to be uplink-transmitted from a sensor (or a sensor capable of acquiring sensor information from the terminal 100) equipped in the terminal 100.

The frame generation unit 1602 generates an uplink radio frame including data such as the sensor information acquired by the sensor information acquisition unit 1601 in the DATA field. For a configuration of the radio frame, refer to FIG. 9.

The radio transmission unit 1603 performs radio transmission of the radio frame generated by the frame generation unit 1602 at the transmission time and the transmission frequency controlled by the radio control unit 1606.

The GPS receiving unit 1604 receives a GPS signal from a GPS satellite and acquires time information and position information. The GPS receiving unit 1604 provides the acquired time information to the radio resource determination unit 1605. Furthermore, in a case where the position information of the terminal 100 itself is transmitted in a radio frame as the sensor information, the position information acquired by the GPS receiving unit 1604 is provided to the frame generation unit 1602.

The radio resource determination unit 1605 determines the transmission time and the transmission frequency of the radio frame on the basis of the time information (GPS time) provided from the GPS receiving unit 1604 and the terminal ID of the terminal 100 itself according to the reference radio resource determination rule, and provides the transmission time and the transmission frequency to the radio control unit 1606.

The radio control unit 1606 controls a radio signal transmission operation by the radio transmission unit 1603 so that radio communication is performed at the transmission time and the transmission frequency an instruction on which is given from the radio resource determination unit 1605.

The terminal 100 is assumed to be an IoT device, but may include components other than those illustrated in FIG. 16 as necessary.

D-5. Terminal Configuration (2)

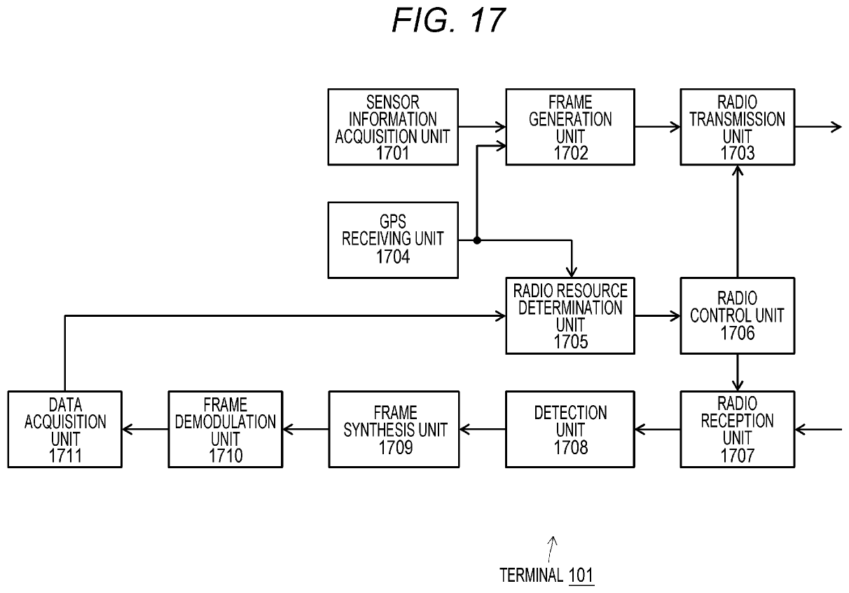

FIG. 17 schematically illustrates a configuration example of the terminal 101. The terminal 101 is a terminal that receives an uplink radio resource control signal and changes a transmission period. The terminal 101 includes a sensor information acquisition unit 1701, a frame generation unit 1702, a radio transmission unit 1703, a GPS receiving unit 1704, a radio resource determination unit 1705, a radio control unit 1706, a radio reception unit 1707, a detection unit 1708, a frame synthesis unit 1709, a frame demodulation unit 1710, and a data acquisition unit 1711.

The sensor information acquisition unit 1701, the frame generation unit 1702, the radio transmission unit 1703, the GPS receiving unit 1704, the radio resource determination unit 1705, and the radio control unit 1706 are components having the same name in the terminal 100 illustrated in FIG. 16, and detailed description of similar operations is omitted.

The radio reception unit 1707 receives a radio signal at a time and a frequency an instruction on which is given from the radio resource determination unit 1706, and converts the radio signal into a baseband signal.

The detection unit 1708 detects a radio frame by calculating the correlation between the unique pattern of the preamble and the received signal. The radio frame detection method is as described above.

The frame synthesis unit 1709 synthesizes radio frames that are repeatedly transmitted. The frame demodulation unit 1710 performs signal processing such as error correction on the received signal after synthesis, further checks CRC, and determines whether or not the radio frame has been successfully received. In the following description, it is assumed that the reception of the radio frame is successful, and the description of the operation when the reception fails is omitted.

When the received radio signal is an uplink radio resource control signal from the base station 200, the data acquisition unit 1711 acquires information of UL Resource Control and provides the information to the radio resource determination unit 1705.

In a case where it is desired to change the UL transmission period, the radio resource determination unit 1705 checks the information of the UL Resource Control provided from the data acquisition unit 1711 and selects the additional radio resource determination rule having a desired transmission period. Then, the radio resource determination unit 1705 recalculates the transmission time and the transmission frequency of the uplink signal on the basis of the GPS time and the ID of the terminal 101 according to the selected additional radio resource determination rule, and provides the transmission time and the transmission frequency to the radio control unit 1706.

The radio control unit 1706 controls a radio signal transmission operation by the radio transmission unit 1703 so that the radio transmission is performed at the transmission time and the transmission frequency recalculated according to the additional radio resource determination rule.

When it is not necessary to change the UL transmission period, the terminal 101 does not perform an operation of receiving a downlink signal (uplink radio resource control signal) from the base station 200. In addition, it is assumed that the operation of the radio resource determination unit 1705 when it is not necessary to change the UL transmission period is similar to the operation of the radio resource determination unit 1605 in the terminal 100 illustrated in FIG. 16.

The terminal 101 is assumed to be an IoT device, but may include components other than those illustrated in FIG. 17 as necessary.

D-6. Base Station Configuration

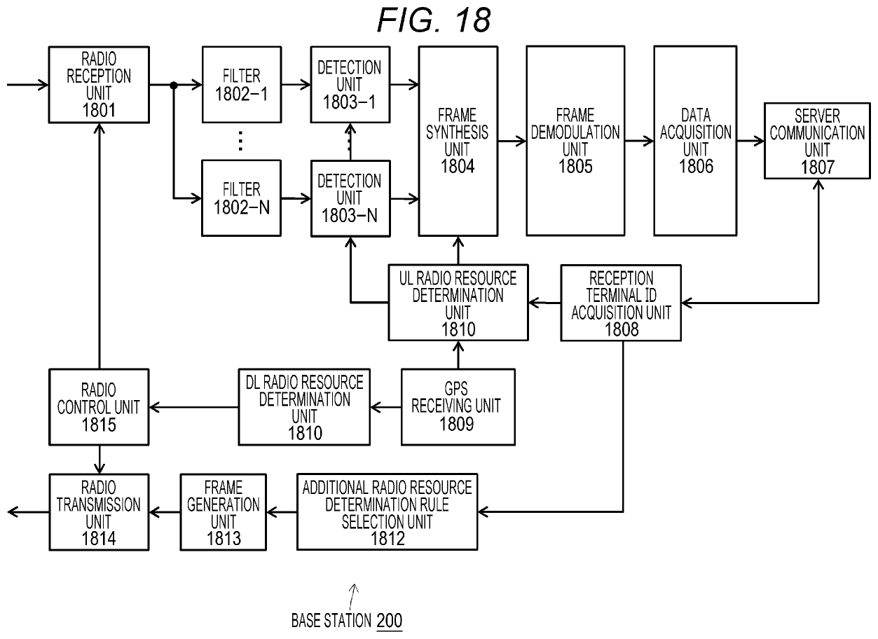

FIG. 18 schematically illustrates a configuration example of the base station 200. The base station 200 includes a radio reception unit 1801, a filter 1802, a detection unit 1803, a frame synthesis unit 1804, a frame demodulation unit 1805, a data acquisition unit 1806, a server communication unit 1807, a reception terminal ID acquisition unit 1808, a GPS receiving unit 1809, an uplink (UL) radio resource determination unit 1810, a downlink (DL) radio resource determination unit 1811, an additional radio resource determination rule selection unit 1812, a frame generation unit 1813, a radio transmission unit 1814, and a radio control unit 1815.

The radio reception unit 1801 operates to receive all frequencies used in the radio system.

The filter 1802 extracts information for each frequency channel from data including all frequencies acquired by the radio reception unit 1801. In the example illustrated in FIG. 18, the filter 1802 includes a plurality of (N) filters (BPF) 1802-1, . . . , and 1802N provided for each frequency (here, N is an integer greater than or equal to 2).

The detection unit 1803 calculates the correlation between the unique pattern of the preamble and the received signal to detect a radio frame. In the example illustrated in FIG. 18, N detection units 1803-1, . . . , and 1803-N are disposed corresponding to the N filters 1802-1, . . . , and 1802N, respectively. Radio frame detection processing is performed on the received signals for each frequency channel output from the plurality of (N) filters (BPF) 1802-1, 1802-2, . . . , and 1802N.

The frame synthesis unit 1804 synthesizes radio frames repeatedly transmitted in each frequency channel.

The frame demodulation unit 1805 performs signal processing such as error correction on the received signal after synthesis, further checks CRC, and determines whether or not the reception of the radio frame is successful. The received radio frame is an uplink signal transmitted from each of the terminal 100 and the terminal 101, and is assumed to have the frame configuration illustrated in FIG. 9. In the following description, it is assumed that the reception of the radio frame is successful, and the description of the operation when the reception fails is omitted.

The data acquisition unit 1806 extracts the ID and the DATA from the payload of the demodulated radio frame, and reports the ID and the DATA to a server (not illustrated) via the server communication unit 1807.

The server communication unit 1807 communicates with a server (not illustrated) via a general wide area line such as the Internet.

The reception terminal ID acquisition unit 1808 acquires a list of terminal IDs to be received by the base station 200 from a server (not illustrated) via the server communication unit 1807, and provides the terminal IDs to be received to the UL radio resource determination unit 1810 and the additional radio resource determination rule selection unit 1812.

The GPS receiving unit 1809 receives a GPS signal from a GPS satellite and acquires time information and position information. GPS receiving unit 1809 provides the acquired time information to the UL radio resource determination unit 1810 and the DL radio resource determination unit 1811.

The UL radio resource determination unit 1810 calculates a reception time and a reception frequency the time information (GPS time) provided from the GPS receiving unit 1809 and the terminal ID to be received, and issues an instruction to the detection units 1803-1, . . . , and 1803N and the frame synthesis unit 1804.

The DL radio resource determination unit 1811 determines a transmission time and a transmission frequency of the downlink signal (uplink radio resource control signal) from the time information (GPS time) provided from the GPS receiving unit 1809 and the ID unique to the radio system, and provides the transmission time and the transmission frequency to the radio control unit 1815.

Upon acquiring the terminal ID to be received from the reception terminal ID acquisition unit 1808, the additional radio resource determination rule selection unit 1812 selects the additional radio resource determination rule to be permitted for the terminal 101 corresponding to each terminal ID. The additional radio resource determination rule selection unit 1812 determines whether or not to permit the additional radio resource determination rule on the basis of the surplus capacity corresponding to the number of terminals to receive the uplink radio frame. For example, when the surplus capacity is sufficient, a radio resource determination rule having a shorter transmission period is additionally permitted.

The frame generation unit 1813 generates a radio frame of a downlink signal, such as an uplink radio resource control signal. The radio frame of the uplink radio resource control signal has the frame configuration illustrated in FIG. 12, for example.

The radio transmission unit 1814 performs radio transmission of the radio frame generated by the frame generation unit 1813 at the transmission time and the transmission frequency controlled by the radio control unit 1815.

The radio control unit 1815 controls the radio reception unit 1801 so that radio signals are received at all frequencies used in the radio system. In addition, the radio control unit 1815 controls the radio transmission unit 1814 so that radio transmission of a downlink signal (uplink radio resource control signal) is performed at the transmission time and the transmission frequency determined by the DL radio resource determination unit 1811.

D-7. Processing Procedure of Terminal

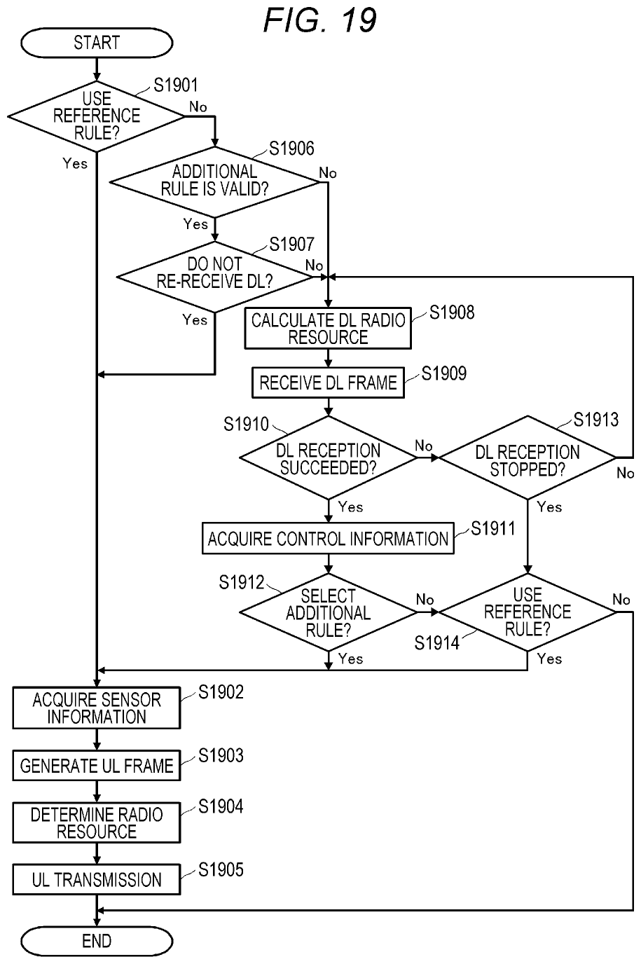

FIG. 19 illustrates a processing procedure executed by the terminal in the form of a flowchart. Here, the terminal referred to herein includes both the terminal 100 that normally operates according to the reference radio resource determination rule and the terminal 101 that changes the transmission period.

First, the terminal checks whether or not to use the reference radio resource determination rule (step S1901).

In a case where the terminal is the terminal 100 that normally operates according to the reference radio resource determination rule, or in a case where the terminal is the terminal 101 but does not change the transmission period in use, it is determined to use the reference radio resource determination rule (Yes in step S1901).

In this case, the terminal acquires the sensor information (step S1902), and generates an uplink radio frame (see FIG. 9) in which the sensor information is described in the DATA field of the payload (step S1903). The terminal determines the transmission time and the transmission frequency on the basis of the GPS time and the terminal ID according to the reference radio resource determination rule (step S1904).

Then, the terminal uplink-transmits the radio frame generated in step S1903 using the radio resource determined in step S1904 at a default transmission period (step S1905).

Further, when the terminal is the terminal 101 that changes the transmission period and wants to change the transmission period due to the above-described reason or the like, it is determined not to use the reference radio resource determination rule (No in step S1901).

In this case, first, the terminal checks whether the additional radio resource determination rule is acquired, and if acquired, whether the additional radio resource determination rule is within the valid period (step S1906).

Then, in a case where the valid additional radio resource determination rule is held (Yes in step S1906), the terminal further checks whether it is necessary to re-receive the uplink radio resource control signal from the base station 200 (step S1907).

When the transmission period corresponding to the currently held additional radio resource determination rule can be maintained or when the default transmission period Period(Def) can be used, the terminal determines that it is not necessary to re-receive the uplink radio resource control signal (Yes in step S1907).

In this case, the terminal acquires the sensor information (step S1902), and generates an uplink radio frame (see FIG. 9) in which the sensor information is described in the DATA field of the payload (step S1903). The terminal determines the transmission time and the transmission frequency on the basis of the GPS time and the terminal ID according to the additional radio resource determination rule (or the reference radio resource determination rule) within the valid period (step S1904), and uplink-transmits the radio frame using the radio resource (step S1905).

When the terminal does not hold the additional radio resource determination rule within the valid period (No in step S1906), or when the uplink radio resource control signal is received again (when the transmission period is to be changed to a shorter transmission period) (No in step S1907), the terminal determines the transmission time and the transmission frequency of the downlink signal (uplink radio resource control signal) on the basis of the GPS time and the ID unique to the radio system (step S1908), and attempts to receive the uplink radio resource control signal from the base station 200 (step S1909).

Then, when the uplink radio resource control signal is successfully received (Yes in step S1910), the terminal acquires information of UL Resource Control from the received signal (step S1911), and selects an additional radio resource determination rule corresponding to a desired transmission period from the additional radio resource determination rules indicated as available (step S1912).

When any of the additional radio resource determination rules is selected (Yes in step S1912), the terminal acquires the sensor information (step S1902), and generates the uplink radio frame (see FIG. 9) in which the sensor information is described in the DATA field of the payload (step S1903). Further, the terminal determines the transmission time and the transmission frequency on the basis of the GPS time and the terminal ID according to the additional radio resource determination rule selected in step S1912 (step S1904), and uplink-transmits the radio frame using the radio resource (step S1905).

When the reception of the uplink radio resource control signal fails (Yes in step S1910), the terminal determines whether or not to stop the reception of the uplink radio resource control signal (step S1913).

When the reception of the uplink radio resource control signal is continued (No in step S1913), the process returns to step S1908, and the terminal repeatedly attempts to receive the uplink radio resource control signal from the ground station 200.

When the reception of the uplink radio resource control signal is stopped (Yes in step S1913), and when none of the additional radio resource determination rules indicated as available is selected (No in step S1912), the terminal determines whether or not to use the reference radio resource determination rule (step S1914).

When it is determined to use the reference radio resource determination rule (Yes in step S1914), the terminal acquires sensor information (step S1902), and generates an uplink radio frame (see FIG. 9) in which the sensor information is described in the DATA field of the payload (step S1903). Then, the terminal determines the transmission time and the transmission frequency on the basis of the GPS time and the terminal ID according to the reference radio resource determination rule (step S1904), and uplink-transmits the radio frame using the radio resource (step S1905).

When it is determined not to use the reference radio resource determination rule (No in step S1914), the terminal ends the process without performing the uplink transmission of the radio frame.

D-8. Processing Procedure of Base Station

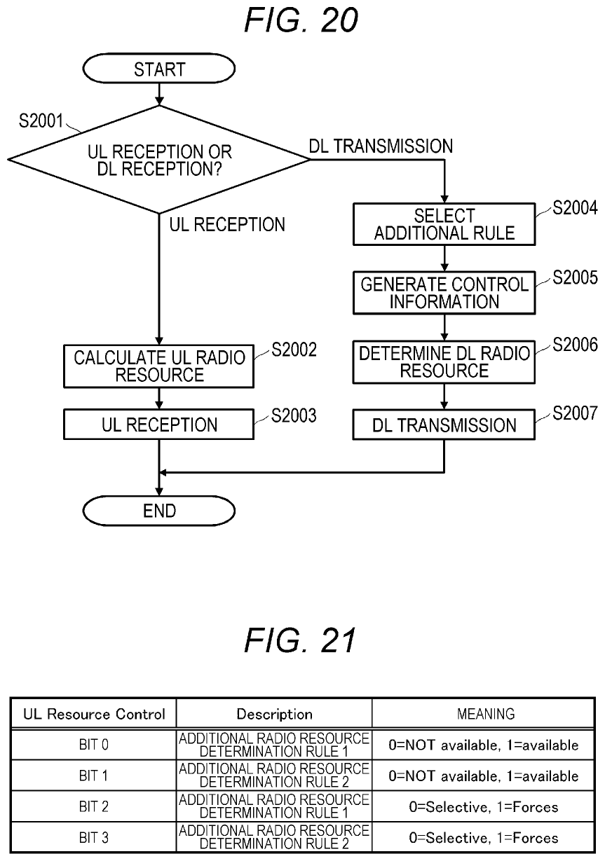

FIG. 20 illustrates a processing procedure executed by the base station 200 in the form of a flowchart.

First, the radio control unit 1815 determines whether to receive an uplink radio frame from the terminal 100 or the terminal 101 or to perform downlink transmission of an uplink radio resource control signal (step S2001).

When it is determined in step S2001 to receive the uplink radio frame, the UL radio resource determination unit 1810 determines the transmission time and the transmission frequency of the uplink radio frame on the basis of the GPS time and the terminal ID to be received (step S2002), issues an instruction to the detection unit 1803 and the frame synthesis unit 1804, receives the uplink radio frame at the transmission time and the transmission frequency determined in step S2002 (step S2003), and ends this process.

On the other hand, when it is determined in step S2001 to transmit the uplink radio resource control signal, the additional radio resource determination rule selection unit 1812 selects a rule to be permitted as the additional radio resource determination rule for the terminal 101 connected to the host station according to the current surplus capacity or the like (step S2004).

Then, the frame generation unit 1813 generates the radio frame of the uplink radio resource control signal including the UL Resource Control information indicating that the use of the additional radio resource determination rule selected in step S2004 is permitted (step S2005).

Next, the DL radio resource determination unit 1811 determines the transmission time and the transmission frequency of the uplink radio resource control signal from the GPS time and the ID unique to the radio system (step S2006).

Next, the radio transmission unit 1814 performs downlink transmission of the uplink radio resource control signal using the transmission time and the transmission frequency determined in step S2006 according to the instruction from the radio control unit 1815 (step S2007), and ends the process.

### Second Embodiment

In the first embodiment, the terminal 100 (or the terminal 101) can arbitrarily select one rule from the additional radio resource determination rules permitted by the base station 200. In the UL Resource Control field 1203 in the payload 1202 of the uplink radio resource control signal illustrated in FIG. 12, a flag (0/1) indicating the availability of an additional radio resource determination rule is described (see FIG. 13). Then, the terminal can arbitrarily select an additional radio resource determination rule in which a flag of 1 is described indicating that it is available.

On the other hand, in the second embodiment, the base station 200 intentionally changes the transmission period of the terminal.

FIG. 21 illustrates a configuration example of the UL Resource Control field 1203 used in the second embodiment. In the drawing, it is assumed that two radio resource determination rules are additionally defined in addition to the reference radio resource determination rule. In order to indicate the availability of each additional radio resource determination rule, a two-bit availability flag of bit 0 and bit 1 is prepared. A two-bit selection freedom flag of bit 2 and bit 3 is further added to indicate the degree of freedom in selecting each additional radio resource rule.

For example, when the additional radio resource determination rule 1 that the terminal 101 wants to switch to is available (bit 0=1) and bit 2=0 (selective), the terminal can freely select the additional radio resource determination rule 1. When the additional radio resource determination rule 1 is available (bit 0=0) and bit 2=1 (forced), the terminal must select the additional radio resource determination rule 1. In the latter case, the base station 200 may force the terminal to select a specific additional radio resource determination rule, and as a result, can inevitably change the transmission period of the sensor information.

For example, when it is desired to temporarily change the transmission period of the terminal on the basis of an instruction from the server 300, the base station 200 may intentionally change the transmission period of the terminal using the information of UL Resource Control as illustrated in FIG. 21. Whether or not the server 300 gives an instruction to change the transmission period of the terminal is determined on the basis of, for example, a contract with a terminal (or the owner of the terminal).

Also in the radio system according to the second embodiment, it is assumed that downlink transmission and uplink transmission are performed between the base station 200 and the terminal 100 and the terminal 101 according to a communication sequence similar to that illustrated in FIG. 15. In addition, it is assumed that the terminal 100 and the terminal 101 can perform a communication operation according to the processing procedure illustrated in FIG. 19, and the base station 200 can perform a communication operation according to the processing procedure illustrated in FIG. 20.

In the present embodiment, when the base station 200 intentionally changes the transmission period of the terminal 100 (or the terminal 101), in step S1912 in the flowchart illustrated in FIG. 19, the terminal further refers to the selection freedom flag of the additional radio resource determination rule indicated as available in the availability flag of the UL Resource Control information, and selects an additional radio resource determination rule.

In addition, in the present embodiment, in a case where the base station 200 intentionally changes the transmission period of the terminal 100 (or the terminal 101), in step S2004 in the flowchart illustrated in FIG. 20, the base station 200 selects one permitted as the additional radio resource determination rule for the terminal connected to the base station, and determines the degree of freedom in selecting each of the permitted additional radio resource determination rules. Then, in subsequent step S2005, the selection freedom flag is described together with the availability flag as the information of UL Resource Control stored in the uplink radio resource control signal.

### Third Embodiment

In the second embodiment, the base station 200 can intentionally change the transmission period of the terminal. However, all terminals that change the transmission period are forced to change the transmission period uniformly.

On the other hand, in the third embodiment, the terminals connected to the base station 200 are grouped into a plurality of groups, and the transmission period of the terminals is intentionally changed in units of groups.

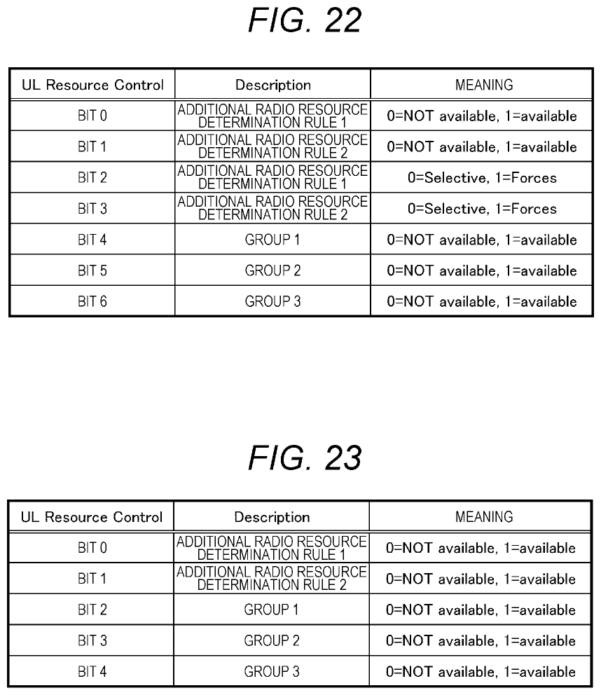

FIG. 22 illustrates a configuration example of the UL Resource Control field 1203 used in the third embodiment. However, it is assumed that a group number is assigned to the terminal separately from the terminal ID of each terminal. In addition, it is assumed that the terminals are grouped into three groups of groups 1 to 3.

In FIG. 22, it is assumed that two radio resource determination rules are additionally defined in addition to the reference radio resource determination rule. In order to indicate the availability of each additional radio resource determination rule, a two-bit availability flag of bit 0 and bit 1 is prepared. Further, a two-bit selection freedom flag of bit 2 and bit 3 is added to indicate the degree of freedom in selecting each additional radio resource rule. Then, for each group of terminals, a 3-bit group availability flag of bit 4 to bit 6 indicating whether or not the information of UL Resource Control is available is further added.

For example, when the additional radio resource determination rule 1 that the terminal 101 wants to switch to is available (bit 0=1) and bit 2=0 (selective), the terminal can freely select the additional radio resource determination rule 1. When the additional radio resource determination rule 1 is available (bit 0=0) and bit 2=1 (forced), the terminal must select the additional radio resource determination rule 1.

In addition, in a case where a terminal belongs to group 1, it is checked whether or not the information of the UL Resource Control is available by further referring to bit 4. When bit 4=1, information of the UL Resource Control is available, and the terminal arbitrarily or forcibly selects the additional radio resource determination rule 1 on the basis of a combination of bit 0 and bit 2, or arbitrarily or forcibly selects the additional radio resource determination rule 2 on the basis of a combination of bit 1 and bit 3. When bit 4=0, since group 1 to which the terminal belongs originally cannot use the information of the UL Resource Control, the terminal cannot switch to either the additional radio resource determination rule 1 or the additional radio resource determination rule 2.

In addition, FIG. 23 illustrates a modification of the UL Resource Control field 1203 used in the third embodiment. However, it is assumed that the terminals are grouped into three groups of groups 1 to 3, and a group number different from the terminal ID is assigned to each group (the same as above).

In FIG. 23, it is assumed that two radio resource determination rules are additionally defined in addition to the reference radio resource determination rule. In order to indicate the availability of each additional radio resource determination rule, a two-bit availability flag of bit 0 and bit 1 is prepared. Further, a 3-bit group availability flag of bits 2 to 5 indicating whether or not the information of UL Resource Control is available is added for each group of terminals. However, unlike the configuration example illustrated in FIG. 22, the UL Resource Control field 1203 does not include a selection freedom flag indicating the degree of freedom in selecting each additional radio resource rule.

For example, when the additional radio resource determination rule 1 that the terminal 101 wants to switch to is available (bit 0=1) and the terminal belongs to group 1, it is checked whether or not the information of the UL Resource Control is available by further referring to bit 2. If bit 2=1, the terminal can use information of this UL Resource Control, and can select the additional radio resource determination rule 1 on the basis of the value of bit 0. When bit 2=0, group 1 to which the terminal belongs cannot use the information of UL Resource Control, and thus the terminal cannot switch to either the additional radio resource determination rule 1 or the additional radio resource determination rule 2.

Also in the radio system according to the third embodiment, it is assumed that downlink transmission and uplink transmission are performed between the base station 200 and the terminal 100 and the terminal 101 according to a communication sequence similar to that illustrated in FIG. 15. In addition, it is assumed that the terminal 100 and the terminal 101 can perform a communication operation according to the processing procedure illustrated in FIG. 19, and the base station 200 can perform a communication operation according to the processing procedure illustrated in FIG. 20.

In the present embodiment, when the base station 200 intentionally changes the transmission period of the terminal 100 (or the terminal 101), in step S1912 in the flowchart illustrated in FIG. 19, the terminal needs to select the additional radio resource determination rule after checking whether the use of the group to which the terminal belongs is permitted by referring to the selection freedom flag of the additional radio resource determination rule indicated as available in the availability flag of the UL Resource Control information and further referring to the group availability flag.

Furthermore, in the present embodiment, in a case where the base station 200 intentionally changes the transmission period of the terminal 100 (or the terminal 101), in step S2004 in the flowchart illustrated in FIG. 20, the base station 200 selects an additional radio resource determination rule to be permitted to be used, determines the degree of freedom in selecting each of the permitted additional radio resource determination rules, and determines whether or not to permit the use of the additional radio resource determination rule for each terminal group. Then, in subsequent step S2005, the group availability flag is described as the information of UL Resource Control stored in the uplink radio resource control signal together with the availability flag and the selection freedom flag of each additional radio resource determination rule.

### Fourth Embodiment

A plurality of sensors may be mounted on each terminal (or the sensor information acquisition unit 1701 of each terminal may be able to acquire sensor information from a plurality of sensors). On the other hand, the server 300 side that aggregates the sensor information from each terminal may not need all the sensor information. When unnecessary sensor information is placed in the DATA field 904 of the uplink radio frame (see FIG. 9), the frame length is increased accordingly, and radio resources are wasted. In addition, the terminal may waste power by the amount of the useless data being transmitted.

Therefore, in the fourth embodiment, a sensor number is assigned to each sensor, and the terminal can specify the type of sensor information to be reported in the uplink radio frame in UL Resource Control. In addition, it is also possible to group terminals connected to the base station 200 into a plurality of groups, assign a group number separately from a terminal ID for each terminal, and specify the type of sensor information to be reported by the terminal in the uplink radio frame in units of groups.

In addition, the base station 200 (or the server 300 that manages the base station) may switch the type of sensor information collected from the terminal 100 every hour. For example, it is also conceivable to operate a radio system in which the type of sensor information is switched depending on daytime or nighttime and good weather or rainy weather.

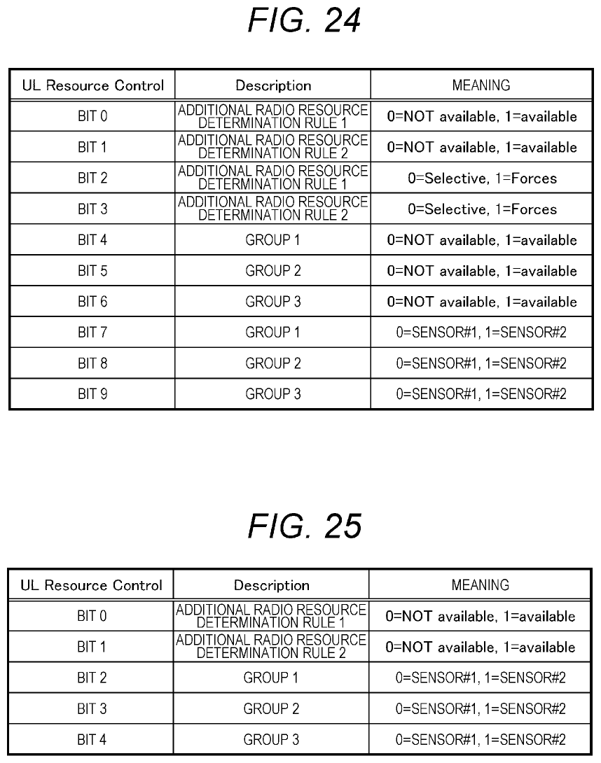

FIG. 24 illustrates a configuration example of the UL Resource Control field 1203 used in the fourth embodiment. However, it is assumed that the terminals are grouped into three groups of groups 1 to 3, and a group number different from the terminal ID is assigned to each group (the same as above). In addition, it is assumed that a sensor number is assigned to each sensor (described above).

In FIG. 24, it is assumed that two radio resource determination rules are additionally defined in addition to the reference radio resource determination rule. In order to indicate the availability of each additional radio resource determination rule, a two-bit availability flag of bit 0 and bit 1 is prepared. Further, in order to indicate the degree of freedom, in selecting each additional radio resource rule, a two-bit selection freedom flag of bit 2 and bit 3 is added. For each group of terminals, a 3-bit group availability flag of bits 4 to 6 indicating whether or not the information of UL Resource Control is available is added. Then, for each group of terminals, a 3-bit sensor type flag of bits 7 to 9 that specifies the type of sensor information to be reported in the uplink radio frame is further added.

For example, when the additional radio resource determination rule 1 that the terminal 101 wants to switch to is available (bit 0=1) and bit 2=0 (selective), the terminal can freely select the additional radio resource determination rule 1. When the additional radio resource determination rule 1 is available (bit 0=0) and bit 2=1 (forced), the terminal must select the additional radio resource determination rule 1.

In addition, in a case where a terminal belongs to group 1, it is checked whether or not the information of the UL Resource Control is available by further referring to bit 4. When bit 4=1, information of the UL Resource Control is available, and the terminal arbitrarily or forcibly selects the additional radio resource determination rule 1 on the basis of a combination of bit 0 and bit 2, or arbitrarily or forcibly selects the additional radio resource determination rule 2 on the basis of a combination of bit 1 and bit 3.

In addition, the terminal belonging to group 1 further refers to bit 7 to recognize that the sensor information of sensor #1 should be stored in the DATA field 904 if bit 7=0, and recognize that the sensor information of sensor #2 should be stored in the DATA field 904 if bit 7=1.

On the other hand, when bit 4=0, since group 1 to which the terminal belongs originally cannot use the information of UL Resource Control, the terminal cannot switch to either the additional radio resource determination rule 1 or the additional radio resource determination rule 2.

In addition, FIG. 25 illustrates a modification of the UL Resource Control field 1203 used in the fifth embodiment. Here, it is assumed that the terminals are grouped into three groups of groups 1 to 3, a group number different from the terminal ID is assigned to each group, and a sensor number is assigned to each sensor (the same as above).

In FIG. 25, it is assumed that two radio resource determination rules are additionally defined in addition to the reference radio resource determination rule. In order to indicate the availability of each additional radio resource determination rule, a two-bit availability flag of bit 0 and bit 1 is prepared. Then, for each group of terminals, a 3-bit sensor type flag of bits 2 to 4 that specifies the type of sensor information to be reported in the uplink radio frame is further added. However, unlike the configuration example illustrated in FIG. 24, the UL Resource Control field 1203 does not include the selection freedom flag indicating the degree of freedom in selecting each additional radio resource rule and the availability flag for each group of terminals.

For example, when the additional radio resource determination rule 1 to which the terminal 101 wants to switch is available (bit 0=1) and the terminal belongs to group 1, the terminal further refers to bit 2 to check the type of sensor information to be reported in the uplink radio frame. Then, if bit 2=0, it is recognized that the sensor information of sensor #1 should be stored in the DATA field 904, and if bit 2=1, it is recognized that the sensor information of sensor #2 should be stored in the DATA field 904.

Also in the radio system according to the fourth embodiment, it is assumed that downlink transmission and uplink transmission are performed between the base station 200 and the terminal 100 and the terminal 101 according to a communication sequence similar to that illustrated in FIG. 15. In addition, it is assumed that the terminal 100 and the terminal 101 can perform a communication operation according to the processing procedure illustrated in FIG. 19, and the base station 200 can perform a communication operation according to the processing procedure illustrated in FIG. 20.

In the present embodiment, when the base station 200 intentionally changes the transmission period of the terminal 100 (or the terminal 101), in step S1912 in the flowchart illustrated in FIG. 19, the terminal needs to select the additional radio resource determination rule by further referring to the selection freedom flag of the additional radio resource determination rule indicated as available in the availability flag of the information of UL Resource Control and the availability flag for each group. Then, when the sensor information is acquired in step S1902 or the uplink radio frame is generated in step S1903, the sensor information specified to the group to which the subject terminal belongs is stored in the DATA field 904 with reference to the sensor type flag.

Furthermore, in the present embodiment, in a case where the base station 200 intentionally changes the transmission period of the terminal 100 (or the terminal 101), in step S2004 in the flowchart illustrated in FIG. 20, the base station 200 selects an additional radio resource determination rule to be permitted to be used, determines the degree of freedom in selecting each of the permitted additional radio resource determination rules, and determines the availability of the additional radio resource determination rule and a sensor type of each terminal group. Then, in subsequent step S2005, the availability flag and the sensor type flag of each group are described as the information of UL Resource Control stored in the uplink radio resource control signal together with the availability flag and the selection freedom flag of each additional radio resource determination rule.

Four embodiments related to the technology proposed in this specification have been described so far, and finally, the effects of the technology proposed in this specification will be summarized.

(1) According to the technology proposed in this specification, in the radio system, a plurality of radio resource determination rules is defined for different transmission periods, and the terminal can switch the transmission period by switching to a radio resource determination rule corresponding to a desired transmission period among the radio resource determination rules permitted by the base station. In the radio system, the base station performs downlink transmission of control information including information on the added radio resource determination rule. In addition, in the radio system, a terminal that can perform transmission without receiving the control information and a terminal that can receive the control information as necessary, select an appropriate radio resource determination rule, and perform transmission can coexist.

(2) The radio resource determination rule defines a method of determining different radio resources for each terminal on the basis of, for example, the GPS time and the terminal ID. In addition, the control information has a short data length including information indicating the availability of a plurality of radio resource determination rules defined for each transmission period in the radio system in the form of a flag or the like. By switching to a radio resource determination rule corresponding to the desired transmission period, the terminal can determine different radio resources for each terminal while changing the transmission period.

(3) The control information downlink-transmitted from the base station may include a selection freedom flag indicating the degree of freedom in selecting each additional radio resource determination rule, a group availability flag indicating the availability of an additional radio resource determination rule for each group of terminals, and a sensor type flag indicating a type of sensor information to be reported by each group. In any case, the data amount of the control information is small. Therefore, the reception time of the terminal can be shortened, and the power consumption of the terminal can be reduced.

(4) The base station can transmit control information with a small amount of data by increasing the transmission energy per bit. As a result, long-distance communication of control information is easily realized, and the base station can control remote terminals altogether.

(5) The base station can intentionally change the transmission period of the terminal by specifying the availability of each radio resource determination rule and the degree of freedom in selecting each radio resource determination rule in the control information. For example, the base station can change the transmission period of the terminal within the range of the surplus capacity of the base station.

(6) In addition, the base station can intentionally change the transmission period of the terminal in units of terminal groups by specifying the availability of the radio resource determination rule and the degree of freedom in selecting the radio resource determination rule for each group of terminals in the control information.

(7) The base station can collect only specific sensor information from terminals by specifying the type of sensor information to be reported by the terminal in the control information. In addition, the base station can specify the type of sensor information for each group of terminals in the control information. For example, the terminal can collect the sensor information of sensor #1 from the terminals belonging to group #1, and at the same time, can collect the sensor information of sensor #2 from the terminals belonging to group #2.

### INDUSTRIAL APPLICABILITY

The technology disclosed in this specification has been described in detail above with reference to specific embodiments. However, it is obvious that those skilled in the art can make modifications and substitutions of the embodiments without departing from the gist of the technology disclosed in this specification.

The technology disclosed in this specification can be mainly applied to the field of IoT to reduce the power consumption of the terminal, reduce the price of the base station, and reduce the cost of the entire radio system. Naturally, the technology proposed in this specification can be similarly applied to various other radio systems in which data transmission needs to be performed without exchanging control information in advance, or various other radio systems in which the data transmission time and the transmission odor of the terminal are determined on the basis of the radio resource determination rule, and the data transmission period of the terminal can be changed as necessary.

In short, the technology disclosed in this specification has been described in the form of exemplification, and the contents described in this specification should not be restrictively interpreted.

In order to determine the gist of the technology disclosed in this specification, the claims should be taken into consideration.

Note that the technology disclosed in this specification can have the following configurations.

(1) A communication apparatus including:

a communication unit that transmits and receives a radio signal;

a determination unit that determines a radio resource to be used by the communication unit; and

a control unit that controls an operation of transmitting and receiving a radio signal by the communication unit on the basis of the radio resource determined by the determination unit, in which

the determination unit determines a radio resource used for transmission of a radio signal according to a radio resource determination rule corresponding to a desired transmission period, and

the control unit performs control so that the radio signal is transmitted from the communication unit at the desired transmission period.

(2) The communication apparatus according to (1), in which

the determination unit calculates a time and a frequency at which the radio signal is transmitted from the communication unit on the basis of time information and an ID of the communication apparatus.

(2-1) The communication apparatus according to (2), further including

a GPS receiving unit that receives a GPS signal, in which

the determination unit calculates a time and a frequency at which the radio signal is transmitted from the communication unit on the basis of a GPS time and an ID of the communication apparatus.

(3) The communication apparatus according to (1) or (2), in which

a plurality of radio resource determination rules is defined for each transmission period, and

the determination unit selects a radio resource determination rule corresponding to a desired transmission period.

(4) The communication apparatus according to any one of (1) to (3), further including:

an acquisition unit that acquires sensor information, in which

the control unit performs control so that the radio signal in which the sensor information is described is transmitted.

(5) The communication apparatus according to any one of (1) to (4), in which

the determination unit determines a radio resource to be used for transmitting a radio signal according to a radio resource determination rule selected from radio resource determination rules whose use is permitted in the control information received by the communication unit.

(6) The communication apparatus according to (5), in which

the determination unit selects a radio resource determination rule specified in the control information.

(7) The communication apparatus according to (5) or (6), in which

the determination unit selects a radio resource determination rule whose use is permitted to a group to which the communication apparatus belongs in the control information.

(8) The communication apparatus according to any one of (5) to (7), in which

the determination unit performs control so that a radio signal in which the sensor information specified in the control information is described is transmitted.

(9) The communication apparatus according to any one of (5) to (8), in which

the control unit performs control so that the control information is received when it is desired to change a transmission period.

(10) The communication apparatus according to any one of (5) to (9), in which

a valid period is set for at least some of radio resource determination rules, and

the control unit performs control so that the control information is received when the valid period of a radio resource determination rule in use has elapsed.

(11) The communication apparatus according to any one of (5) to (10), in which

the determination unit calculates a time and a frequency at which the control information is received from a connection destination base station on the basis of the time information and the ID of the radio system.

(11-1) The communication apparatus according to (11), further including

a GPS receiving unit that receives a GPS signal, in which

the determination unit calculates a time and a frequency at which the control information is received from the base station on the basis of a GPS time and an ID of the radio system.

(12) A communication method including:

determining a radio resource determination rule to be used on the basis of control information;

determining a radio resource to be used for transmitting a radio signal according to a radio resource determination rule; and

transmitting the radio signal at a transmission period corresponding to the radio resource determination rule.

(13) A communication apparatus including:

a communication unit that transmits and receives a radio signal;

a determination unit that determines a radio resource to be used by the communication unit; and

a control unit that control an operation of transmitting and receiving a radio signal by the communication unit on the basis of the radio resource determined by the determination unit, in which

the control unit performs control so that a radio signal including control information related to a radio resource determination rule for determining a radio resource to be used for transmitting a radio signal addressed to the communication apparatus is transmitted using the radio resource determined by the determination unit.

(13-1) The communication apparatus according to (13), in which

the determination unit calculates a time and a frequency at which the radio signal is transmitted on the basis of time information and an ID of a radio system.

(13-2) The communication apparatus according to (13-1), further including

a GPS receiving unit that receives a GPS signal, in which

the determination unit calculates a time and a frequency at which the radio signal is transmitted on the basis of a GPS time and an ID of the radio system.

(14) The communication apparatus according to (13), in which

a plurality of radio resource determination rules is defined, and

the control unit performs control so that the control information in which information regarding availability of each radio resource determination rule is described is transmitted.

(15) The communication apparatus according to (14), in which

the control unit performs control so that the control information further describing information regarding a degree of freedom in selecting each of the plurality of radio resource determination rules is transmitted.

(16) The communication apparatus according to (14) or (15), in which

the control unit performs control so that the control information further describing information regarding availability of each of the plurality of radio resource determination rules for each group of terminals is transmitted.

(17) The communication apparatus according to any one of (14) to (16), in which

the control unit performs control so that the control information further describing information regarding a type of sensor information to be transmitted is transmitted.

(18) The communication apparatus according to any one of (13) to (17), in which

the control unit performs control so that the control information is transmitted every predetermined valid period.

(19) The communication apparatus according to any one of (13) to (18), in which

the plurality of radio resource determination rules corresponding to different transmission periods is defined, and

the control unit performs control so that the control information in which information regarding availability of each radio resource determination rule according to a surplus capacity of the communication apparatus is described is transmitted.

(20) A communication method including:

selecting a radio resource determination rule for determining a radio resource to be used for transmitting a radio signal addressed thereto;

determining a radio resource to be used for transmitting a radio signal including control information related to the selected radio resource determination rule; and

transmitting the radio signal using the determined radio resource.

### DESCRIPTION OF REFERENCE SYMBOLS

100 Terminal
101 Terminal
200 Base station
300 Server
1000 Correlation calculator
1001 to 1004 Delay element
1005 Addition block
1011 to 1014 Multiplier
1601 Sensor information acquisition unit
1602 Frame generation unit
1603 Radio transmission unit
1604 GPS receiving unit
1605 Radio resource determination unit
1606 Control unit
1701 Sensor information acquisition unit
1702 Frame generation unit
1703 Radio transmission unit
1704 GPS receiving unit
1705 Radio resource determination unit
1706 Control unit
1707 Radio reception unit
1708 Detection unit
1709 Frame synthesis unit
1710 Frame demodulation unit
1711 Data acquisition unit
1801 Radio reception unit
1802 Filter
1803 Detection unit
1804 Frame synthesis unit
1805 Frame demodulation unit
1806 Data acquisition unit
1807 Server communication unit
1808 Reception terminal ID acquisition unit
1809 GPS receiving unit
1810 UL radio resource determination unit
1811 DL radio resource determination unit
1812 Additional radio resource determination rule selection unit
1813 Frame generation unit
1814 Radio transmission unit
1815 Radio control unit

1. A communication apparatus comprising:
a communication unit that transmits and receives a radio signal;
a determination unit that determines a radio resource to be used by the communication unit; and
a control unit that controls an operation of transmitting and receiving a radio signal by the communication unit on a basis of the radio resource determined by the determination unit, wherein
the determination unit determines a radio resource used for transmission of a radio signal according to a radio resource determination rule corresponding to a desired transmission period, and
the control unit performs control so that the radio signal is transmitted from the communication unit at the desired transmission period.

2. The communication apparatus according to claim 1, wherein
the determination unit calculates a time and a frequency at which the radio signal is transmitted from the communication unit on a basis of time information and an ID of the communication apparatus.

3. The communication apparatus according to claim 1, wherein
a plurality of radio resource determination rules is defined for each transmission period, and
the determination unit selects a radio resource determination rule corresponding to a desired transmission period.

4. The communication apparatus according to claim 1, further comprising:
an acquisition unit that acquires sensor information, wherein
the control unit performs control so that the radio signal in which the sensor information is described is transmitted.

5. The communication apparatus according to claim 1, wherein
the determination unit determines a radio resource to be used for transmitting a radio signal according to a radio resource determination rule selected from radio resource determination rules whose use is permitted in the control information received by the communication unit.

6. The communication apparatus according to claim 5, wherein
the determination unit selects a radio resource determination rule specified in the control information.

7. The communication apparatus according to claim 5, wherein
the determination unit selects a radio resource determination rule whose use is permitted to a group to which the communication apparatus belongs in the control information.

8. The communication apparatus according to claim 5, wherein
the determination unit performs control so that a radio signal in which the sensor information specified in the control information is described is transmitted.

9. The communication apparatus according to claim 5, wherein
the control unit performs control so that the control information is received when it is desired to change a transmission period.

10. The communication apparatus according to claim 5, wherein
a valid period is set for at least some of radio resource determination rules, and
the control unit performs control so that the control information is received when the valid period of a radio resource determination rule in use has elapsed.

11. The communication apparatus according to claim 5, wherein
the determination unit calculates a time and a frequency at which the control information is received from a connection destination base station on a basis of the time information and the ID of the radio system.

12. A communication method comprising:
determining a radio resource determination rule to be used on a basis of control information;
determining a radio resource to be used for transmitting a radio signal according to a radio resource determination rule; and
transmitting the radio signal at a transmission period corresponding to the radio resource determination rule.

13. A communication apparatus comprising:
a communication unit that transmits and receives a radio signal;
a determination unit that determines a radio resource to be used by the communication unit; and
a control unit that control an operation of transmitting and receiving a radio signal by the communication unit on a basis of the radio resource determined by the determination unit, wherein
the control unit performs control so that a radio signal including control information related to a radio resource determination rule for determining a radio resource to be used for transmitting a radio signal addressed to the communication apparatus is transmitted using the radio resource determined by the determination unit.

14. The communication apparatus according to claim 13, wherein
a plurality of radio resource determination rules is defined, and
the control unit performs control so that the control information in which information regarding availability of each radio resource determination rule is described is transmitted.

15. The communication apparatus according to claim 14, wherein
the control unit performs control so that the control information further describing information regarding a degree of freedom in selecting each of the plurality of radio resource determination rules is transmitted.

16. The communication apparatus according to claim 14, wherein
the control unit performs control so that the control information further describing information regarding availability of each of the plurality of radio resource determination rules for each group of terminals is transmitted.

17. The communication apparatus according to claim 14, wherein
the control unit performs control so that the control information further describing information regarding a type of sensor information to be transmitted is transmitted.

18. The communication apparatus according to claim 13, wherein
the control unit performs control so that the control information is transmitted every predetermined valid period.

19. The communication apparatus according to claim 13, wherein
the plurality of radio resource determination rules corresponding to different transmission periods is defined, and
the control unit performs control so that the control information in which information regarding availability of each radio resource determination rule according to a surplus capacity of the communication apparatus is described is transmitted.

20. A communication method comprising:
selecting a radio resource determination rule for determining a radio resource to be used for transmitting a radio signal addressed thereto;
a radio resource to be used for transmitting a radio signal including control information related to the selected radio resource determination rule; and
transmitting the radio signal using the determined radio resource.
